(19) United States
(12) Patent Application Publication
(10) Pub. No.: US 2017/0300956 A1
(43) Pub. Date: Oct. 19, 2017

(54) SYSTEMS AND METHODS TO GENERATE COUPON OFFERINGS TO IDENTIFIED CUSTOMERS

(71) Applicant: Wal-Mart Stores, Inc., Bentonville, AR (US)

(72) Inventors: Robert L. Cantrell, Herndon, VA (US); Bruce W. Wilkinson, Rogers, AR (US); Todd D. Mattingly, Bentonville, AR (US)

(21) Appl. No.: 15/487,792

(22) Filed: Apr. 14, 2017

Related U.S. Application Data
(60) Provisional application No. 62/323,026, filed on Apr. 15, 2016.
(60) Provisional application No. 62/348,444, filed on Jun. 10, 2016.
(60) Provisional application No. 62/436,842, filed on Dec. 20, 2016.
(60) Provisional application No. 62/485,045, filed on Apr. 13, 2017.
(60) Provisional application No. 62/402,711, filed on Sep. 30, 2016.
(60) Provisional application No. 62/442,631, filed on Jan. 5, 2017.

(51) Int. Cl. G06Q 30/02

(52) U.S. Cl. CPC G06Q 30/0239; G06Q 30/0269

(57) ABSTRACT

Some embodiments provide a retail product coupon offer distribution system, comprising: a customer profile database comprising customer profiles comprises a set of customer partiality vectors; a product profile database comprising product profiles each comprising a set of product partiality vectors; and a product management control circuit configured to: identify a set of customers having a customer partiality vector that has a threshold alignment with at least one product partiality vector; and for each customer of the set, customizes a coupon offer relative to the first product that is distinct for each customer.

### RELATED APPLICATIONS

This application claims the benefit of each of the following U.S. Provisional applications, each of which is incorporated herein by reference in its entirety: 62/323,026 filed Apr. 15, 2016 (Attorney Docket No. 8842-137893-USPR_1235US01); 62/348,444 filed Jun. 10, 2016 (Attorney Docket No. 8842-138849-USPR_3677US01); 62/436,842 filed Dec. 20, 2016 (Attorney Docket No. 8842-140072-USPR_3678US01); 62/485,045, filed Apr. 13, 2017 (Attorney Docket No. 8842-140820-USPR_4211US01); 62/442,631, filed Jan. 5, 2017 (Attorney Docket No. 8842-139531-USPR_2051US01); and 62/402,711, filed Sep. 30, 2016 (Attorney Docket No. 8842-139453-USPR_2873US01).

### TECHNICAL FIELD

These teachings relate generally to providing products and services to individuals and in some cases, relates to identifying marketing opportunities.

### BACKGROUND

Various shopping paradigms are known in the art. One approach of long-standing use essentially comprises displaying a variety of different goods at a shared physical location and allowing consumers to view/experience those offerings as they wish to thereby make their purchasing selections. This model is being increasingly challenged due at least in part to the logistical and temporal inefficiencies that accompany this approach and also because this approach does not assure that a product best suited to a particular consumer will in fact be available for that consumer to purchase at the time of their visit.

Increasing efforts are being made to present a given consumer with one or more purchasing options that are selected based upon some preference of the consumer. When done properly, this approach can help to avoid presenting the consumer with things that they might not wish to consider. That said, existing preference-based approaches nevertheless leave much to be desired. Information regarding preferences, for example, may tend to be very product specific and accordingly may have little value apart from use with a very specific product or product category. As a result, while helpful, a preferences-based approach is inherently very limited in scope and offers only a very weak platform by which to assess a wide variety of product and service categories.

In modern retail services there is a need to improve the customer service and/or convenience for the customer. One aspect of customer convenience is a customer's ability to find desired products. There are numerous ways to allow a customer to shop. However, there is a need to improve a customer's ability to shop.

### BRIEF DESCRIPTION OF THE DRAWINGS

The above needs are at least partially met through provision of the vector-based characterizations of products described in the following detailed description, particularly when studied in conjunction with the drawings. Disclosed herein are embodiments of systems, apparatuses and methods pertaining to the generation of coupon offerings to identified customers. This description includes drawings, wherein:

FIG. 1 comprises a flow diagram as configured in accordance with various embodiments of these teachings;

FIG. 2 comprises a flow diagram as configured in accordance with various embodiments of these teachings;

FIG. 3 comprises a graphic representation as configured in accordance with various embodiments of these teachings;

FIG. 4 comprises a graph as configured in accordance with various embodiments of these teachings;

FIG. 5 comprises a flow diagram as configured in accordance with various embodiments of these teachings;

FIG. 6 comprises a graphic representation as configured in accordance with various embodiments of these teachings;

FIG. 7 comprises a graphic representation as configured in accordance with various embodiments of these teachings;

FIG. 8 comprises a graphic representation as configured in accordance with various embodiments of these teachings;

FIG. 9 comprises a flow diagram as configured in accordance with various embodiments of these teachings;

FIG. 10 comprises a flow diagram as configured in accordance with various embodiments of these teachings;

FIG. 11 comprises a graphic representation as configured in accordance with various embodiments of these teachings;

FIG. 12 comprises a graphic representation as configured in accordance with various embodiments of these teachings;

FIG. 13 comprises a block diagram as configured in accordance with various embodiments of these teachings;

FIG. 14 comprises a flow diagram as configured in accordance with various embodiments of these teachings;

FIG. 15 comprises a graph as configured in accordance with various embodiments of these teachings;

FIG. 16 comprises a flow diagram as configured in accordance with various embodiments of these teachings;

FIG. 17 comprises a block diagram as configured in accordance with various embodiments of these teachings;

FIG. 18 illustrates a simplified block diagram of a retail product coupon offer distribution system that distributes customized coupon offers, in accordance with some embodiments;

FIG. 19 illustrates an exemplary system for use in implementing methods, techniques, devices, apparatuses, systems, servers, sources and providing access to rendered retail environments, in accordance with some embodiments;

FIG. 20 illustrates a simplified flow diagram of an exemplary process of distributing retail product coupon offerings, in accordance with some embodiments;

FIG. 21 comprises a flow diagram as configured in accordance with various embodiments of these teachings;

FIG. 22 comprises a block diagram as configured in accordance with various embodiments of these teachings;

FIG. 23 comprises a flow diagram as configured in accordance with various embodiments of these teachings;

FIG. 24 comprises a flow diagram as configured in accordance with various embodiments of these teachings; and

FIG. 25 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are described herein that provide for precision retail product coupon offer distribution. Some embodiments include one or more databases, such as but not limited to one or more customer profile databases, one or more product profile databases, and/or other such databases. The customer profile database can include customer profiles of numerous customers, with each customer profile being associated with one of the customers. Further, the customer profiles can include a set of at least one customer partiality vectors. The partiality vectors can have a magnitude that corresponds to a determined magnitude of a strength of the belief, by the customer, in an amount of good and/or reduced effort that comes from an amount of order imposed upon material space-time by a corresponding particular partiality. The one or more product profile databases can store and maintain product profiles that each correspond to one of multiple different products. Each product profile comprises a set of product partiality vectors having at least a magnitude that represents a reduction of exerted effort associated with the corresponding product to pursue a corresponding partiality.

The system further includes one or more product management control circuits communicatively coupled with the customer profile database and the product profile database. The product management control circuit identifies a set of customers of the multiple customers that each have associated a customer partiality vector that has a threshold relationship with at least one product partiality vector of the set of product partiality vectors associated with a first product. Further, the product management control circuit is configured to customize, for each customer of the set of customers, one or more coupon offers relative to at least the first product that is distinct for each customer of the set of customers based on the at least one product partiality vector associated with the customer and the first product. The coupon distribution system can cause the customized coupon offer to be communicated over a distributed communications network to be received through a customer computing device by the respective customer.

Generally speaking, many of these embodiments provide for a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality. This memory can also contain vectorized characterizations for each of a plurality of products, wherein each of the vectorized characterizations includes a measure regarding an extent to which a corresponding one of the products accords with a corresponding one of the plurality of partiality vectors.

Rules can then be provided that use the aforementioned information in support of a wide variety of activities and results. Although the described vector-based approaches bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

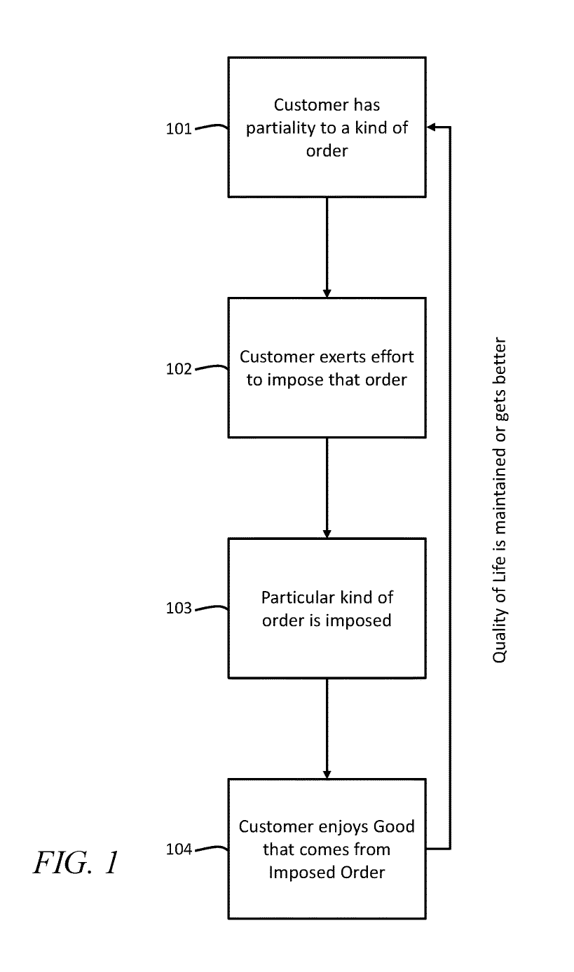

FIG. 1 provides a simple illustrative example in these regards. At block 101 it is understood that a particular person has a partiality (to a greater or lesser extent) to a particular kind of order. At block 102 that person willingly exerts effort to impose that order to thereby, at block 103, achieve an arrangement to which they are partial. And at block 104, this person appreciates the “good” that comes from successfully imposing the order to which they are partial, in effect establishing a positive feedback loop.

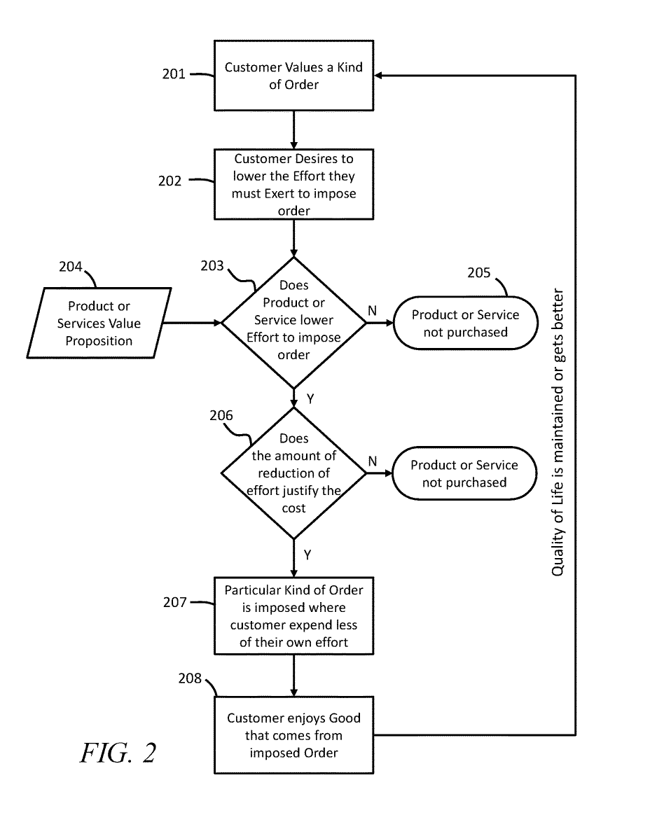

Understanding these partialities to particular kinds of order can be helpful to understanding how receptive a particular person may be to purchasing a given product or service. FIG. 2 provides a simple illustrative example in these regards. At block 201 it is understood that a particular person values a particular kind of order. At block 202 it is understood (or at least presumed) that this person wishes to lower the effort (or is at least receptive to lowering the effort) that they must personally exert to impose that order. At decision block 203 (and with access to information 204 regarding relevant products and or services) a determination can be made whether a particular product or service lowers the effort required by this person to impose the desired order. When such is not the case, it can be concluded that the person will not likely purchase such a product/service 205 (presuming better choices are available).

When the product or service does lower the effort required to impose the desired order, however, at block 206 a determination can be made as to whether the amount of the reduction of effort justifies the cost of purchasing and/or using the proffered product/service. If the cost does not justify the reduction of effort, it can again be concluded that the person will not likely purchase such a product/service 205. When the reduction of effort does justify the cost, however, this person may be presumed to want to purchase the product/service and thereby achieve the desired order (or at least an improvement with respect to that order) with less expenditure of their own personal effort (block 207) and thereby achieve, at block 208, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

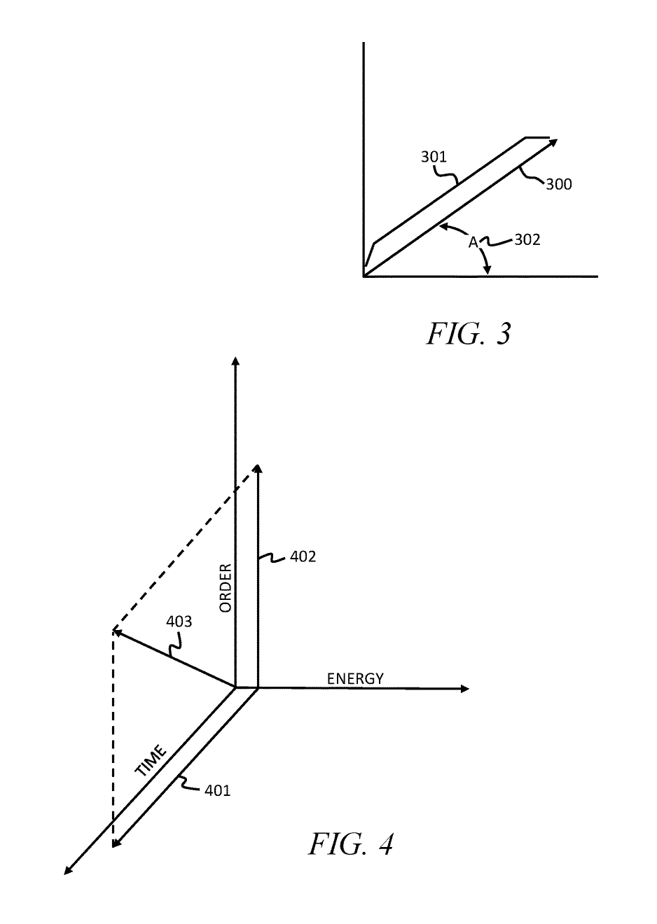

FIG. 3 provides some illustrative examples in these regards. By one approach the vector 300 has a corresponding magnitude 301 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 301, the greater the strength of that belief and vice versa. Per another example, the vector 300 has a corresponding angle A 302 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

FIG. 4 presents a space graph that illustrates many of the foregoing points. A first vector 401 represents the time required to make such a wristwatch while a second vector 402 represents the order associated with such a device (in this case, that order essentially represents the skill of the craftsman). These two vectors 401 and 402 in turn sum to form a third vector 403 that constitutes a value vector for this wristwatch. This value vector 403, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ {W}_{1} … {W}_{n} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience).

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

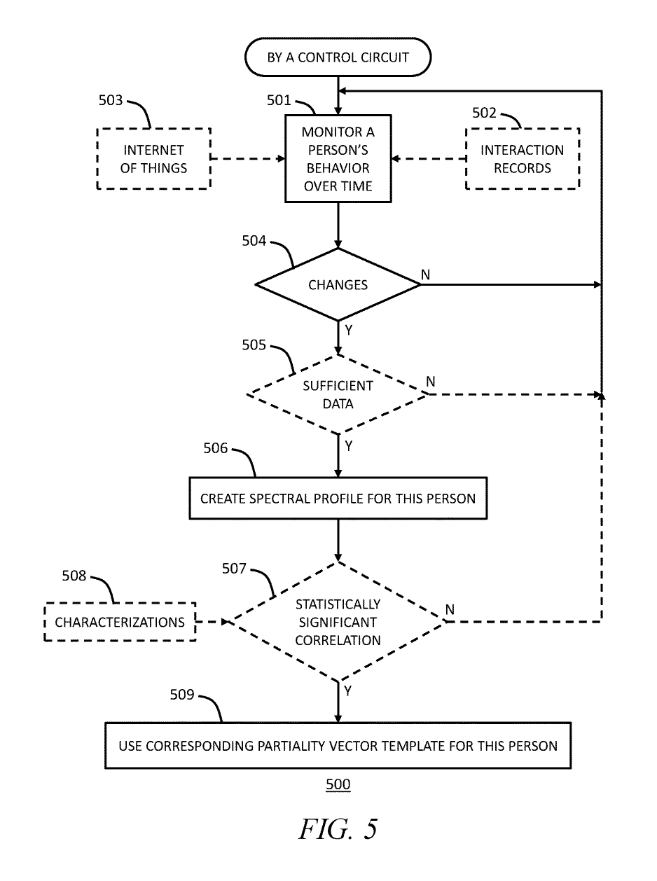

FIG. 5 presents a process 500 that illustrates yet another approach in these regards. For the sake of an illustrative example it will be presumed here that a control circuit of choice (with useful examples in these regards being presented further below) carries out one or more of the described steps/actions.

At block 501 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 502 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 502 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (IOT) 503. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020. (Further description in these regards appears further herein.)

Depending upon what sensors a person encounters, information can be available regarding a person's travels, lifestyle, calorie expenditure over time, diet, habits, interests and affinities, choices and assumed risks, and so forth. This process 500 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 504 this process 500 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 505 this process 500 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

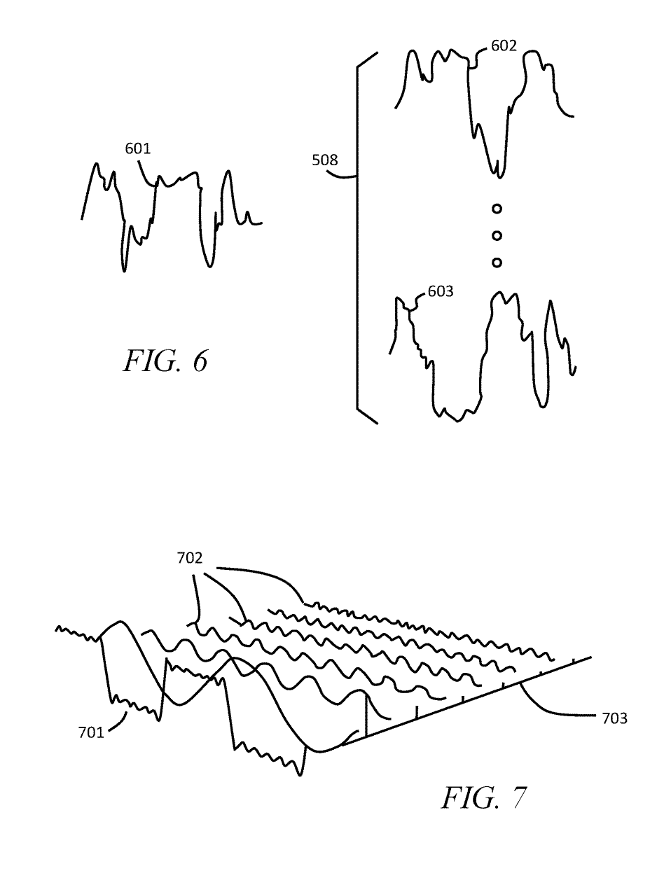

At block 507 this process 500 uses these detected changes to create a spectral profile for the monitored person. FIG. 6 provides an illustrative example in these regards with the spectral profile denoted by reference numeral 601. In this illustrative example the spectral profile 601 represents changes to the person's behavior over a given period of time (such as an hour, a day, a week, or some other temporal window of choice). Such a spectral profile can be as multidimensional as may suit the needs of a given application setting.

At optional block 507 this process 500 then provides for determining whether there is a statistically significant correlation between the aforementioned spectral profile and any of a plurality of like characterizations 508. The like characterizations 508 can comprise, for example, spectral profiles that represent an average of groupings of people who share many of the same (or all of the same) identified partialities. As a very simple illustrative example in these regards, a first such characterization 602 might represent a composite view of a first group of people who have three similar partialities but a dissimilar fourth partiality while another of the characterizations 603 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 508 are based and/or the amount of data and/or the duration of time over which data is available for the monitored person.

Referring now to FIG. 7, by one approach the selected characterization (denoted by reference numeral 701 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 701 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 7 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 7) in the same sense as, for example, a radio or acoustic wave, it will nevertheless be understood that such a behavioral characterization 701 can itself be broken down into a plurality of sub-waves 702 that, when summed together, equal or at least approximate to some satisfactory degree the behavioral characterization 701 itself (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 703 wherein the X axis represents frequency and the Y axis represents the magnitude of the response of the monitored person at each frequency/sub-wave of interest.

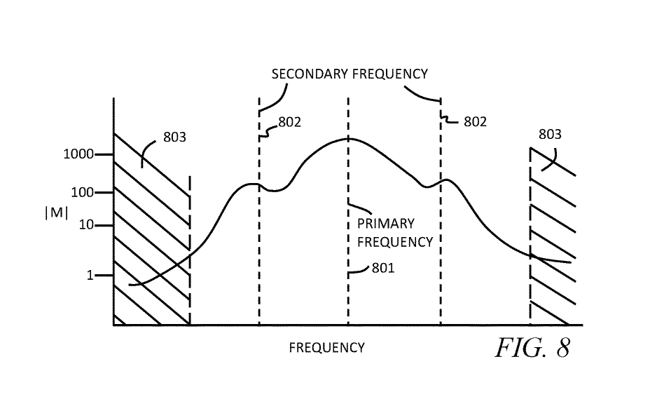

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 8, for many people the spectral profile of the individual person will exhibit a primary frequency 801 for which the greatest response (perhaps many orders of magnitude greater than other evident frequencies) to life is exhibited and apparent. In addition, the spectral profile may also possibly identify one or more secondary frequencies 802 above and/or below that primary frequency 801. (It may be useful in many application settings to filter out more distant frequencies 803 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 701, those partialities can be used as an initial template for a person whose own behaviors permit the selection of that particular characterization 701. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product)

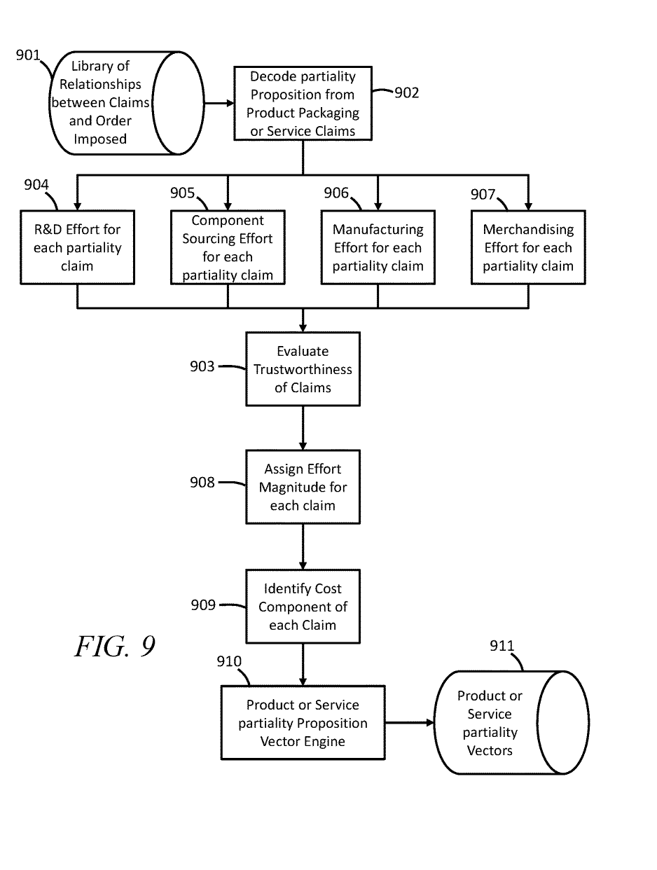

FIG. 9 presents one non-limiting illustrative example in these regards. The illustrated process presumes the availability of a library 901 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 902 this process provides for decoding one or more partiality propositions from specific product packaging (or service claims). For example, the particular textual/graphics-based claims presented on the packaging of a given product can be used to access the aforementioned library 901 to identify one or more corresponding imposed orders from which one or more corresponding partialities can then be identified.

At block 903 this process provides for evaluating the trustworthiness of the aforementioned claims. This evaluation can be based upon any one or more of a variety of data points as desired. FIG. 9 illustrates four significant possibilities in these regards. For example, at block 904 an actual or estimated research and development effort can be quantified for each claim pertaining to a partiality. At block 905 an actual or estimated component sourcing effort for the product in question can be quantified for each claim pertaining to a partiality. At block 906 an actual or estimated manufacturing effort for the product in question can be quantified for each claim pertaining to a partiality. And at block 907 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 908 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 909 this process provides for identifying a cost component of each claim, this cost component representing a monetary value. At block 910 this process can use the foregoing information with a product/service partiality propositions vector engine to generate a library 911 of one or more corresponding partiality vectors for the processed products/services. Such a library can then be used as described herein in conjunction with partiality vector information for various persons to identify, for example, products/services that are well aligned with the partialities of specific individuals.

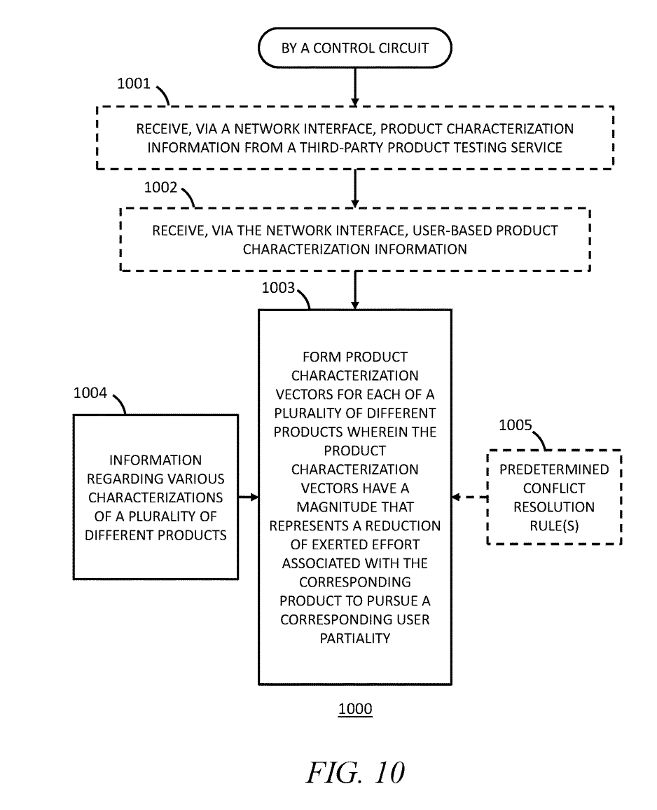

FIG. 10 provides another illustrative example in these same regards and may be employed in lieu of the foregoing or in total or partial combination therewith. Generally speaking, this process 1000 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 10, this process 1000 can be carried out by a control circuit of choice. Specific examples of control circuits are provided elsewhere herein.

As described further herein in detail, this process 1000 makes use of information regarding various characterizations of a plurality of different products. These teachings are highly flexible in practice and will accommodate a wide variety of possible information sources and types of information. By one optional approach, and as shown at optional block 1001, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself.)

As another example, and as illustrated at optional block 1002, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1000 provides for accessing (see block 1004) information regarding various characterizations of each of a plurality of different products. This information 1004 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1004 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1003 the control circuit uses the foregoing information 1004 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1004. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1005 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1004 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

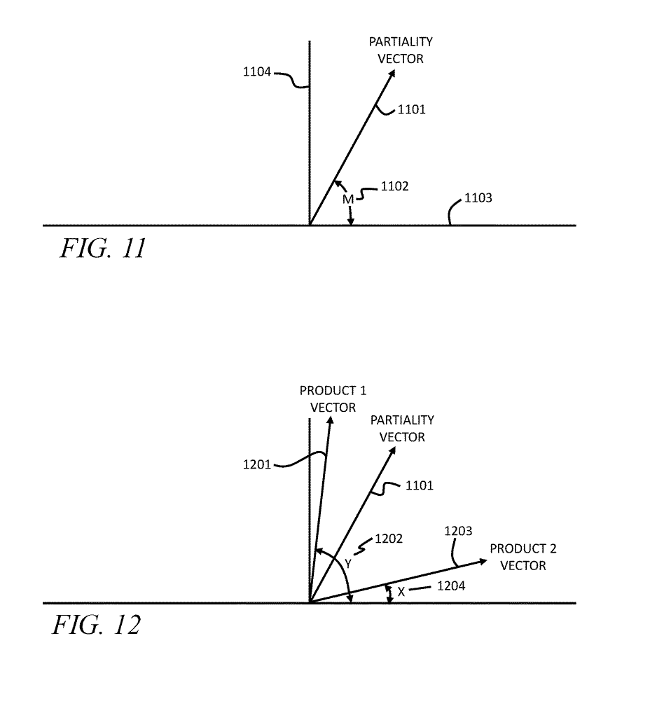

As noted above, the magnitude corresponding to a particular partiality vector for a particular person can be expressed by the angle of that partiality vector. FIG. 11 provides an illustrative example in these regards. In this example the partiality vector 1101 has an angle M 1102 (and where the range of available positive magnitudes range from a minimal magnitude represented by 0° (as denoted by reference numeral 1103) to a maximum magnitude represented by 90° (as denoted by reference numeral 1104)). Accordingly, the person to whom this partiality vector 1001 pertains has a relatively strong (but not absolute) belief in an amount of good that comes from an order associated with that partiality.

FIG. 12, in turn, presents that partiality vector 1101 in context with the product characterization vectors 1201 and 1203 for a first product and a second product, respectively. In this example the product characterization vector 1201 for the first product has an angle Y 1202 that is greater than the angle M 1102 for the aforementioned partiality vector 1101 by a relatively small amount while the product characterization vector 1203 for the second product has an angle X 1204 that is considerably smaller than the angle M 1102 for the partiality vector 1101.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1201 with the partiality vector 1101 will be larger than the resultant scaler value for the vector dot product of the product 2 vector 1203 with the partiality vector 1101. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv·P1v) might equal (1,1), hence yielding a scalar result of ∥1∥ (where Cv refers to the corresponding partiality vector for this person and Ply represents the corresponding product characterization vector for these organic apples). Conversely, a dot product result for this same person with respect to a product characterization vector(s) for non-organic apples that represent a cost of $5 on a weekly basis (i.e., Cv·P2v) might instead equal (1,0), hence yielding a scalar result of ∥½∥. Accordingly, although the organic apples cost more than the non-organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥½∥), but the dot product for the $10/week organic apples may now drop (for example, to ∥½∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

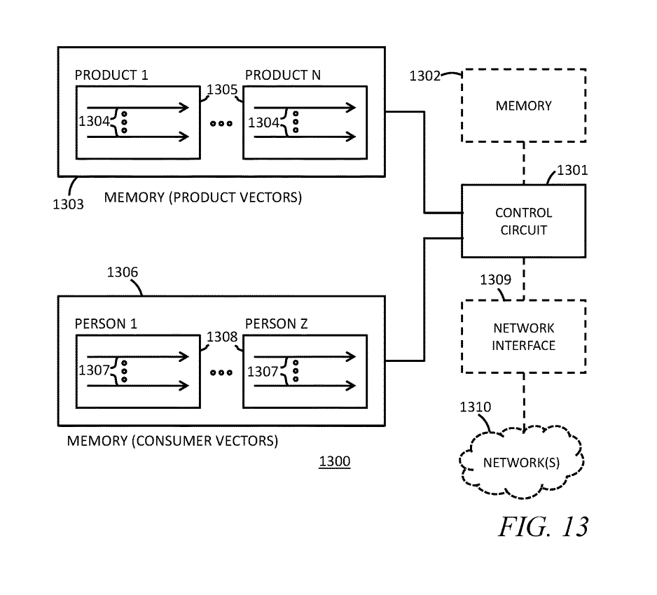

FIG. 13 presents an illustrative apparatus 1300 for conducting, containing, and utilizing the foregoing content and capabilities. In this particular example, the enabling apparatus 1300 includes a control circuit 1301. Being a “circuit,” the control circuit 1301 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1301 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1301 is configured (for example, by using corresponding programming as will be well understood by those skilled in the art) to carry out one or more of the steps, actions, and/or functions described herein.

By one optional approach the control circuit 1301 operably couples to a memory 1302. This memory 1302 may be integral to the control circuit 1301 or can be physically discrete (in whole or in part) from the control circuit 1301 as desired. This memory 1302 can also be local with respect to the control circuit 1301 (where, for example, both share a common circuit board, chassis, power supply, and/or housing) or can be partially or wholly remote with respect to the control circuit 1301 (where, for example, the memory 1302 is physically located in another facility, metropolitan area, or even country as compared to the control circuit 1301).

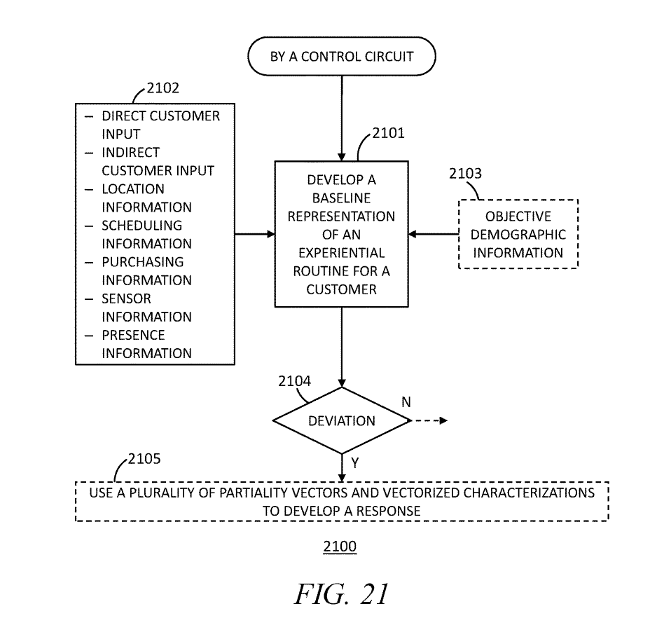

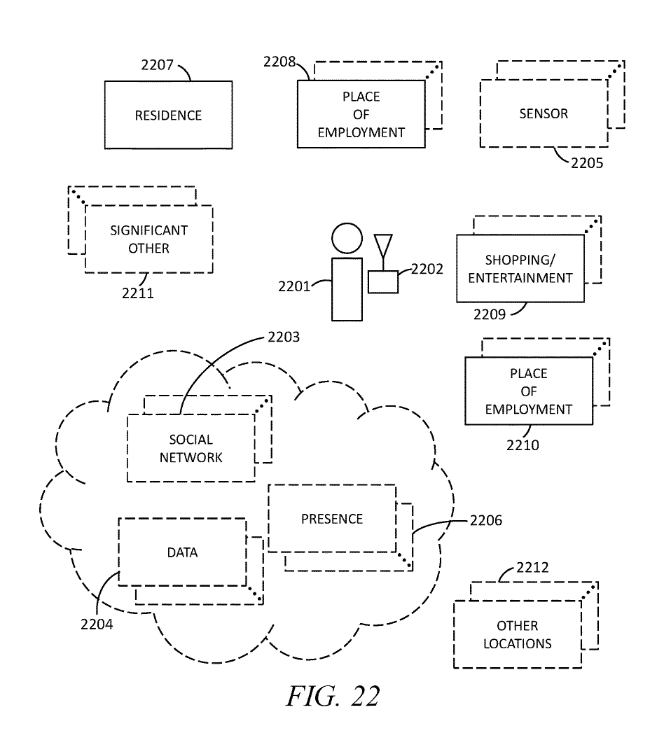

This memory 1302 can serve, for example, to non-transitorily store the computer instructions that, when executed by the control circuit 1301, cause the control circuit 1301 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).) This memory 602 can also serve to store, for example, information regarding a routine experiential base state for one or more customers (as described herein in more detail) and/or expert inputs pertaining, for example, to identifying customer aspirations, the extent of a customer's aspirations, and products/services that can/will assist a customer to realize a particular aspiration (e.g., see the description of FIGS. 21-25 and the corresponding description).

Either stored in this memory 1302 or, as illustrated, in a separate memory 1303 are the vectorized characterizations 1304 for each of a plurality of products 1305 (represented here by a first product through an Nth product where “N” is an integer greater than “1”). In addition, and again either stored in this memory 1302 or, as illustrated, in a separate memory 1306 are the vectorized characterizations 1307 for each of a plurality of individual persons 1308 (represented here by a first person through a Zth person wherein “Z” is also an integer greater than “1”).

In this example the control circuit 1301 also operably couples to a network interface 1309. So configured the control circuit 1301 can communicate with other elements (both within the apparatus 1300 and external thereto) via the network interface 1309. Network interfaces, including both wireless and non-wireless platforms, are well understood in the art and require no particular elaboration here. This network interface 1309 can compatibly communicate via whatever network or networks 1310 may be appropriate to suit the particular needs of a given application setting. Both communication networks and network interfaces are well understood areas of prior art endeavor and therefore no further elaboration will be provided here in those regards for the sake of brevity.

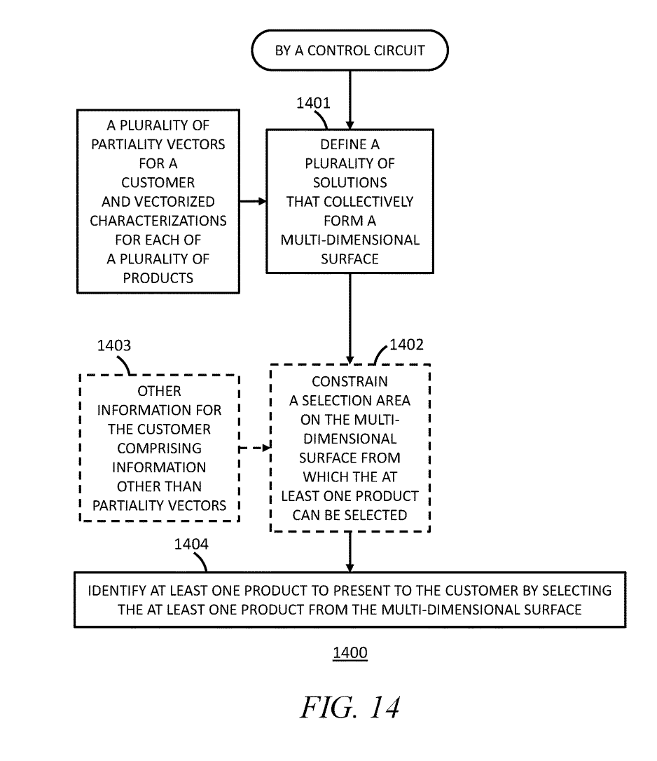

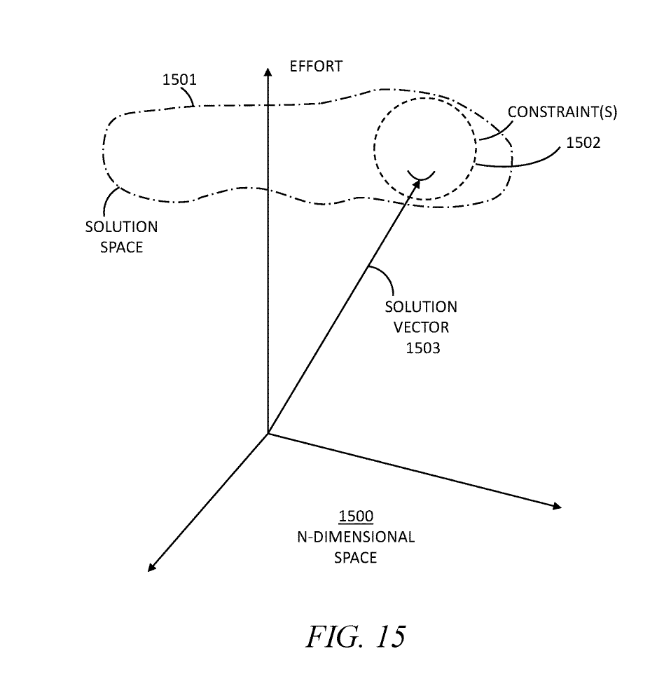

By one approach, and referring now to FIG. 14, the control circuit 1301 is configured to use the aforementioned partiality vectors 1307 and the vectorized product characterizations 1304 to define a plurality of solutions that collectively form a multidimensional surface (per block 1401). FIG. 15 provides an illustrative example in these regards. FIG. 15 represents an N-dimensional space 1500 and where the aforementioned information for a particular customer yielded a multi-dimensional surface denoted by reference numeral 1501. (The relevant value space is an N-dimensional space where the belief in the value of a particular ordering of one's life only acts on value propositions in that space as a function of a least-effort functional relationship.)

Generally speaking, this surface 1501 represents all possible solutions based upon the foregoing information. Accordingly, in a typical application setting this surface 1501 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 14 and 15, at optional block 1402 the control circuit 1301 can be configured to use information for the customer 1403 (other than the aforementioned partiality vectors 1307) to constrain a selection area 1502 on the multi-dimensional surface 1501 from which at least one product can be selected for this particular customer. By one approach, for example, the constraints can be selected such that the resultant selection area 1502 represents the best 95th percentile of the solution space. Other target sizes for the selection area 1502 are of course possible and may be useful in a given application setting.

The aforementioned other information 1403 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or planned/scheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1502), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1404 the control circuit 1301 can then identify at least one product to present to the customer by selecting that product from the multi-dimensional surface 1501. In the example of FIG. 15, where constraints have been used to define a reduced selection area 1502, the control circuit 1301 is constrained to select that product from within that selection area 1502. For example, and in accordance with the description provided herein, the control circuit 1301 can select that product via solution vector 1503 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1301 may respond per these teachings to learning that the customer is planning a party that will include seven other invited individuals. The control circuit 1301 may therefore be looking to identify one or more particular beverages to present to the customer for consideration in those regards. The aforementioned partiality vectors 1307 and vectorized product characterizations 1304 can serve to define a corresponding multi-dimensional surface 1501 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1502 to beverages that contain no alcohol. As another example in these regards, the control circuit 1301 may have objective information that the party is to be held in a state park that prohibits alcohol and may therefore similarly constrain the available selection area 1502 to beverages that contain no alcohol.

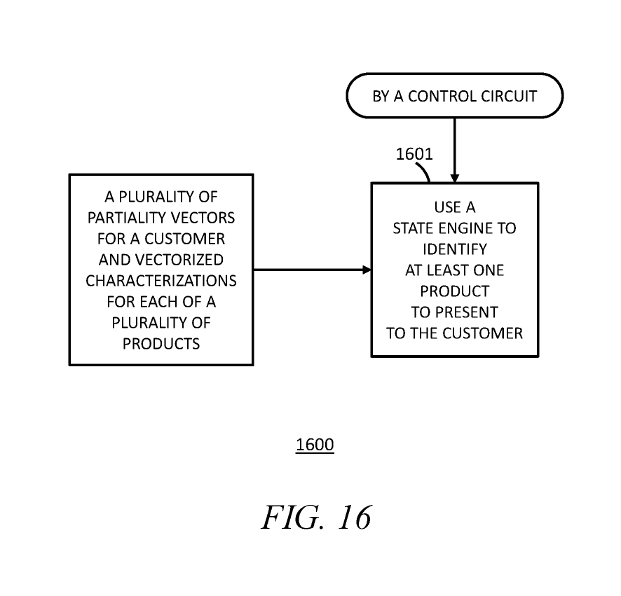

As described above, the aforementioned control circuit 1301 can utilize information including a plurality of partiality vectors for a particular customer along with vectorized product characterizations for each of a plurality of products to identify at least one product to present to a customer. By one approach 1600, and referring to FIG. 16, the control circuit 1301 can be configured as (or to use) a state engine to identify such a product (as indicated at block 1601). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

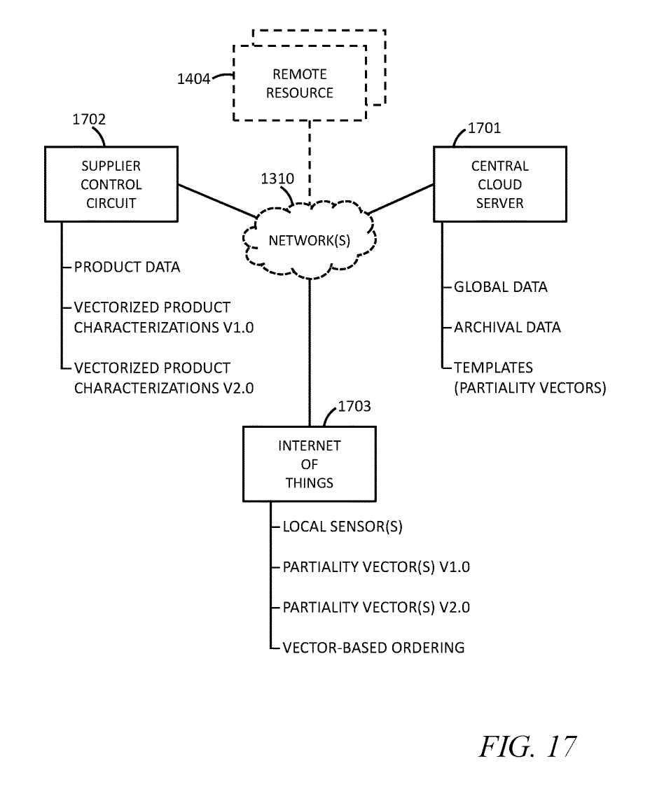

It will be appreciated that the apparatus 1300 described above can be viewed as a literal physical architecture or, if desired, as a logical construct. For example, these teachings can be enabled and operated in a highly centralized manner (as might be suggested when viewing that apparatus 1300 as a physical construct) or, conversely, can be enabled and operated in a highly decentralized manner. FIG. 17 provides an example as regards the latter.

In this illustrative example a central cloud server 1701, a supplier control circuit 1702, and the aforementioned Internet of Things 1703 communicate via the aforementioned network 1310.

The central cloud server 1701 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 1701 that store identical, overlapping, or wholly distinct content.)

The supplier control circuit 1702 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 17 by the expression “vectorized product characterizations V1.0”) for a given product as well as subsequent, updated vectorized product characterizations (denoted in FIG. 17 by the expression “vectorized product characterizations V2.0”) for the same product. Such modifications may have been made by the supplier control circuit 1702 itself or may have been made in conjunction with or wholly by an external resource as desired.

The Internet of Things 1703 can comprise any of a variety of devices and components that may include local sensors that can provide information regarding a corresponding user's circumstances, behaviors, and reactions back to, for example, the aforementioned central cloud server 1701 and the supplier control circuit 1702 to facilitate the development of corresponding partiality vectors for that corresponding user. Again, however, these teachings will also support a decentralized approach. In many cases devices that are fairly considered to be members of the Internet of Things 1703 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 1702 and use that information in conjunction with local partiality vector information to facilitate the vector-based ordering.

Also, if desired, the smart phone in this example can itself modify and update partiality vectors for the corresponding user. To illustrate this idea in FIG. 17, this device can utilize, for example, information gained at least in part from local sensors to update a locally-stored partiality vector (represented in FIG. 17 by the expression “partiality vector V1.0”) to obtain an updated locally-stored partiality vector (represented in FIG. 17 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 1704. These remote resources 1704 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

Illustrative examples in these regards are provided below where appropriate.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that accumulates when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

FIG. 21 provides a more specific illustrative example in these regards. Pursuant to this process 2100 the control circuit 1301 (at block 2101) develops a baseline representation of an experiential routine for a customer. Such a baseline representation can include, for example, a typical daily event timeline for the customer that represents typical locations that the customer visits and/or typical activities in which the customer engages. The timeline can indicate those activities that tend to be scheduled (such as the customer's time at their place of employment or their time spent at their child's sports practices) as well as visits/activities that are normal for the customer though not necessarily undertaken with strict observance to a corresponding schedule (such as visits to local stores, movie theaters, and the homes of nearby friends and relatives).

The control circuit 1301 can develop (and also update and maintain) such a baseline representation using any of a variety of information sources 2102. These teachings are not overly sensitive to any particular choices in these regards. A number of useful possibilities in these regards will now be presented, but it will be understood that no particular limitations are intended by the specificity of these examples. These examples are made with reference to both FIGS. 21 and 22.

By one approach the information can include information directly input by the customer 2201 (for example, via the customer's corresponding portable device 2202 such as a so-called smart phone, pad/tablet-styled computer, wrist-worn device, pendant-style device, head-worn device, and/or a device that comprises part of an article of clothing). Such a portable device 2202 can have a user interface by which the customer 2201 enters their information. The portable device 2202 can also have a wireless interface by which the portable device 2202 transmits that information to a corresponding network element by which the control circuit 1301 eventually gains access to either a verbatim version of that customer input or an abridged or otherwise modified form thereof.

By one approach the customer 2201 provides this input in response to questions or other opportunities provided directly by the control circuit 1301 or otherwise by the enterprise that operates and controls the control circuit 1301. As one non-limiting illustrative example in these regards, the customer's direct input may comprise feedback from the customer 2201 as regards a response provided by the control circuit 1301 pursuant to this described process 2100. By another approach the customer 2201 provides this input to another service or in response to another opportunity, with the immediate or eventual intent that the information be shared with the enterprise that operates/controls the control circuit 1301.

By another approach, in lieu of the foregoing or in combination therewith, the information 2102 provided to the control circuit 1301 can include any of a variety of indirect customer inputs. As one example in these regards, the information may comprise social networking postings corresponding to (or made by) the customer 2201 that appear on one or more social networks 2203 frequented by the customer 2201. This can include such things as posted text messages, still images, and videos as well as “likes,” comments, selected emoticons, “friend” and “link” choices, and so forth. As another related example in these regards, the information may reflect web surfing activities corresponding to the customer 2201. For example, the particular websites, pages, articles and so forth that the customer 2201 is or has accessed and/or bookmarked.

As another example, the information 2102 provided to the control circuit 1301 can comprise location information for the customer 2201. Such location information may be sourced by the customer's portable device 2202 when the latter has, for example, location-determining capabilities (such as a global positioning system (GPS) receiver). A customer's location may also be gleaned, in whole or in part, from other information sources including but not limited to surveillance cameras, social networking posts and updates, traffic cameras, mobile analytics data, Wi-Fi and Bluetooth access point registrations, radio-frequency identification (RFID) tag and near-field tag reads, and so forth as may be available and where the customer 2201 may have approved of such usage.

As another example, the information 2102 provided to the control circuit 1301 can comprise scheduling information corresponding to the customer 2201. This scheduling information may be gleaned, for example, from a calendar application maintained and used by the customer 2201 on their portable device 2202. By another approach this scheduling information may be gleaned from a cloud-sourced data repository 2204 that the customer 2201 employs for that purpose. In some cases scheduling information may also be gleaned from the customer's emails, Tweets, and social-networking communications to the extent that the customer 2201 has again approved of such usage. Examples of useful scheduling information include appointments and scheduled events that identify locations and/or activities that correspond to particular identified days and times.

As another example, the information 2102 provided to the control circuit 1301 can comprise purchasing information corresponding to the customer 2201. As one illustrative example in these regards, the customer 2201 may personally submit scans of their retail receipts and/or other identifying information regarding their purchases directly to the control circuit 1301 or another related network entity. The shopping venues, shopping times, and purchased items that are typical for the customer 2201 can all help the control circuit 1301 to develop the corresponding baseline representation of the customer's experiential routine.

As yet another example, the information 2102 provided to the control circuit 1301 can include information provided by any of a wide variety of sensors 2205. By one approach, the relevant sensor may comprise a part of the customer's portable device 2202. Examples in these regards include location and movement sensors, direction of movement sensors, audio sensors, temperature sensors, altitude sensors, device usage sensors, and any of a wide variety of biological sensors (such as pulse sensors, step sensors, and so forth).

In other cases the sensors 2205 may comprise third-party devices that are remotely located with respect to the customer 2201. As one example in these regards, the sensor information may be sourced by a vehicle that corresponds to the customer 2201. Examples of information can include location information, navigation/destination information, information/entertainment settings, number of occupants, and so forth. As another example the sensor 2205 may serve to monitor and track the web surfing activities of the customer 2201.

And as yet another example in these regards, the information 2102 provided to the control circuit 1301 may comprise presence information corresponding to the customer 2201. That presence information can represent a physical presence of the customer (for example, the physical presence of the customer 2201 at a particular store) or can represent a virtual presence of the customer (for example, the virtual presence of the customer 2201 in a multi-player networked video game). By one approach, such presence information might be obtained (on a push or a pull basis as desired) from one or more relevant presence servers 2206 as are known in the art.

In addition to the foregoing, this process 2100 will also accommodate having the control circuit 1301 develop the aforementioned baseline representation using objective demographic information 2103 regarding the customer 2201. Examples of objective demographic information include but are not limited to customer name information, family information, address information, budget information, age information, gender information, and race information.

Using objective demographic information 2103, for example, the control circuit 1301 can select a particular template from a plurality of candidate templates that each comprise a generic baseline representation of an experiential routine for customers who share similar objective demographic information. So configured, the control circuit 1301 can use the template in situations where little other more-specific information regarding the customer is available to nevertheless develop a baseline representation of a likely experiential routine for the customer. In that case, the control circuit 1301 can be configured to use later-received supplemental information that is more specifically regarding the customer to modify/personalize the selected generic baseline representation of an experiential routine for the customer to then use as a non-generic baseline representation going forward from that point.

At block 2104, the control circuit 1301 can detect a deviation from the developed baseline representation and can then respond accordingly. In particular, and as illustrated at optional block 2105, the control circuit 1301 can use the aforementioned plurality of partiality vectors 1307 for this customer 2201 and the vectorized product characterizations 1304 to develop such a response. For example, in response to detecting the aforementioned deviation the control circuit 1301 can identify at least one product to assist the customer with restoring the customer's order consistent with the partiality vectors. Or, as another example, the control circuit 1301 can identify at least one product to assist the customer with realizing an aspiration.

The response can also optionally comprise updating the aforementioned baseline representation of the experiential routine for the customer 2201. For example, it may be determined that the detected deviation in fact represents a new normal event for the customer 2201. When true, the control circuit 1301 can update the baseline representation such that the experiential routine for the customer includes this event.

So configured, and with particular reference to FIG. 22, as a particular customer 2201 goes about their day (moving, for example, amongst and between their residence 2207, their place (or places) of employment 2208, one or more shopping/entertainment venues 2209, any of a variety of child-based venues 2210 (such as schools, extracurricular venues, and so forth), the homes or other locations of significant others 2211 (such as spouses, parents, close relatives, and friends), and any number of other locations 2212) and engages in travels and/or activities that are both routine and non-routine, these teachings permit the control circuit 1301 to identify when deviations to the ordinary occur and to use the aforementioned partiality vectors and vectorized product characterizations to identify useful corresponding responses.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

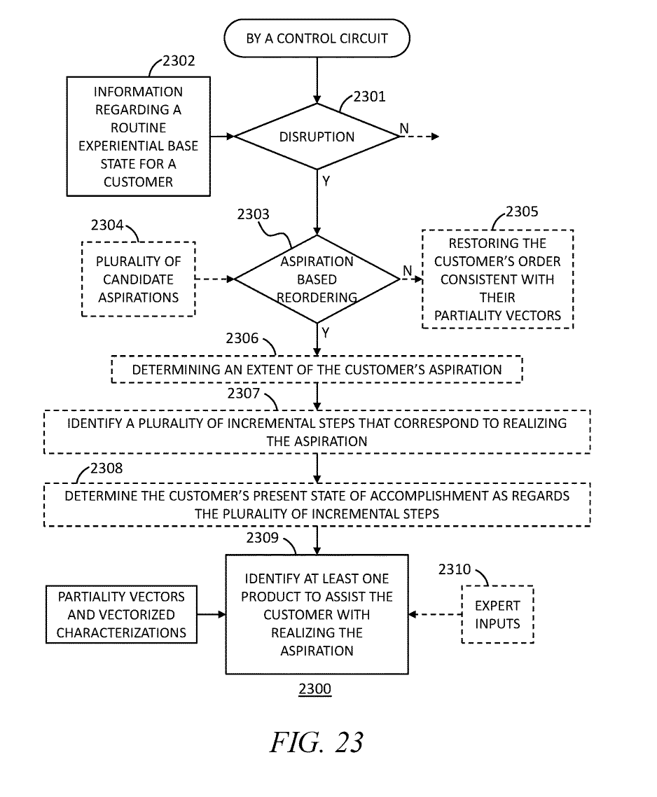

FIG. 23 presents a particular illustrative example in these regards. Pursuant to this process 2300, the control circuit 1301, at block 2301, detects a disruption to the routine experiential base state for a particular customer. Generally speaking, the control circuit 1301 can compare circumstances that pertain to this particular customer with information 2302 regarding a routine experiential base state for a customer (the latter being understood and developed as per the foregoing description). Those referred-to “circumstances” can comprise information representing real-time circumstances for the customer, recent-history circumstances for the customer (such as information regarding the last five minutes, 15 minutes, or one hour for the customer as desired), or even historical information for this customer (such as information regarding the previous day or the previous week for this particular customer).

The specifics of the aforementioned comparison can vary with respect to the details of the information regarding the routine experiential base state for the customer. For example, when the latter only constitutes locations visited by the customer per a particular schedule, then the comparison will likely include detecting when the customer visits other locations and/or when the customer visits previously-noted locations pursuant to a different schedule. As noted above, a baseline representation of an experiential routine for a particular customer can be based upon many different categories of information. Accordingly, the information regarding the routine experiential base state for a customer can be as generalized or as nuanced and rich as may be desired and/or as authorized by the customer.

Upon detecting a disruption to the routine experiential base state for the customer, at block 2303 the control circuit 1301 can determine whether the disruption is one that is occasioned by the customer reordering their life towards realizing an aspiration (as versus a disruption representing a more negative circumstance). By one approach, the control circuit 1301 makes this determination by identifying the particular aspiration that has occasioned the disruption.

This determination, in turn, may be based upon the control circuit 1301 disambiguating amongst a plurality of candidate aspirations 2304 that may all be consistent to a greater or lesser extent with the detected disruption. To put this another way, the control circuit 1301 may assess each of a plurality of aspirations that have previously been associated with this particular customer to determine which aspiration seems most likely to explain the detected disruption. (If desired, these teachings will also accommodate referring to various aspirations that have not been previously associated with this particular customer when looking to determine whether the detected disruption is the result of the customer reordering their life towards realizing a new aspiration.)

When the disruption is not the result of the customer realizing an aspiration, this process 2300 will optionally accommodate, as illustrated at optional block 2305, using the aforementioned partiality vectors 1307 and the vectorized product characterizations 1304 to identify at least one product to assist the customer with restoring their order consistent with their partiality vectors as described elsewhere herein.

When the disruption is the result of an aspiration-based reordering, however, this process 2300 will accommodate an optional determination (illustrated at optional block 2306) regarding an extent of the customer's identified aspiration. Generally speaking, many aspirations can be fairly viewed using a scale of relative achievement. The aspiration of being a good cook, for example, can range from a modest goal of learning to cook homemade nutritious meals using mostly locally-sourced products to attending and graduating from Le Cordon Bleu. Understanding and characterizing such a scale can be accomplished in a variety of ways including with the benefit, guidance, and input of subject-matter experts.

Also if desired, and as illustrated at optional block 2307, this process 2300 will accommodate identifying a plurality of incremental steps that correspond to realizing the identified aspiration. The granularity of these steps can be as general or as nuanced as desired. And again, identifying the incremental steps that can be reliably undertaken to achieve a particular aspiration can be accomplished in a variety of ways including with the benefit, guidance, and input of subjects-matter experts.

When such steps are identified or otherwise available, at optional block 2308 the control circuit 1301 can determine the customer's present state of accomplishment as regards that plurality of incremental steps to thereby identify a particular one of the plurality of incremental steps. This determination may be wholly or partially automated where information regarding activities, skills, and/or accomplishments of the customer are compared against characterizing information for each of the aforementioned incremental steps to identify which step most closely matches the customer's present state of apparent capability in those regards. This determination may also be wholly or partially undertaken through expert assessment, analysis, and assignment. These teachings will also accommodate prompting the customer to provide their own self-assessment in these regards.

At block 2309 this process 2300 provides for identifying at least one product to assist the customer with realizing the identified aspiration. By one approach, the control circuit 1301 can use the partiality vectors 1307 for this customer and appropriate vectorized product characterizations 1304 when identifying such a product. These teachings will also accommodate, if desired, using expert inputs 2310 when identifying such a product.

These teachings are highly practical and will accommodate a variety of modifications and or supplemented activity as desired. As one illustrative example in these regards, when the customer's present state of accomplishment as regards a plurality of incremental steps that correspond to realizing the identified aspiration is available, these teachings will accommodate identifying at least one product to assist the customer with accomplishing a corresponding selected one of the plurality of incremental steps. As one simple example in these regards, when the customer's aspiration is to be a world-class cook and to achieve a next reasonable step in achieving this aspiration they will need additional cookware that they presently lack, the relevant partiality vectors and vectorized product characterizations can serve to identify, at least in part, additional cookware that is not only consistent with achieving the customer's aspiration but that is also most consistent with their own partialities.

Such a product, once identified, can be offered to the customer using any of a variety of approaches. For example, if desired, the identified product can be provided without cost to the customer. Such an approach can serve, for example, to test the extent of the customer's aspiration (by noting, for example, the customer's follow-on behavior, such as whether the customer returns the product without any further related activity, whether the customer keeps the product (with or without a corresponding payment by the customer depending upon the arrangement), or whether the customer returns the product but makes a subsequent related but substitute purchase that is consistent with the aspiration but which may shed further light on the extent of the customer's aspiration and/or the customer's own level-of-accomplishment in those regards.

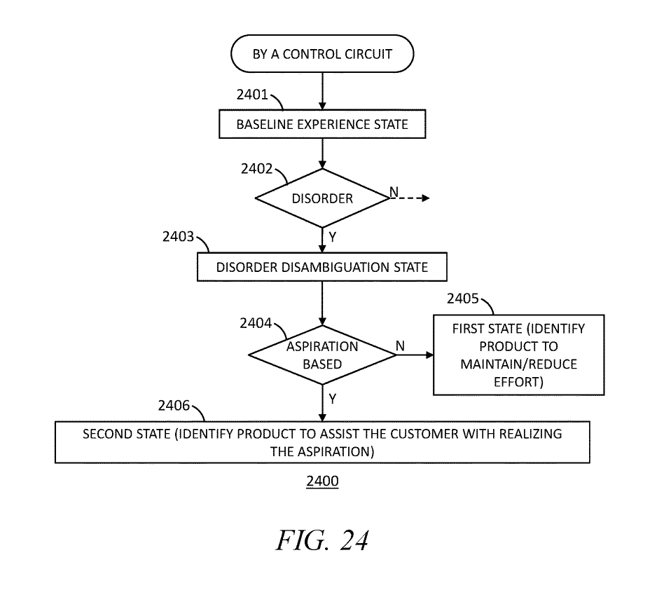

As noted previously, these teachings will accommodate configuring the control circuit 1301 as a state engine to carry out some or all of the activities described herein. FIG. 24 provides an illustrative example in these regards in the context of servicing a customer's aspirations per the foregoing description.

Per this process 2400, the control circuit 1301, configured as a state engine, has a customer baseline experience state 2401. This state can reflect and constitute the aforementioned baseline representation of an experiential routine for a particular customer.

At block 2402 the state engine, upon detecting disorder with respect to the customer's baseline experience state, transitions to a disorder disambiguation state 2403. This state serves to determine (at block 2404) when the detected disorder comprises a disruption occasion by the customer when reordering their life towards realizing an aspiration, or conversely, when the disruption is otherwise occasioned. When the disruption is not owing to an aspiration, the state engine transitions to a first state 2405 pursuant to which the control circuit 1301 processes the customer's partiality vectors 1307 and vectorized product characterizations 1304 to identify a product to at least maintain or to reduce the customer's corresponding effort.

When the disorder is the result of an aspiration, however, the state engine transitions to a second state 2406 to process partiality vectors 1307 and vectorized product characterizations 1304 to identify at least one product to assist the customer with realizing the aspiration (for example, as per the description provided above).

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

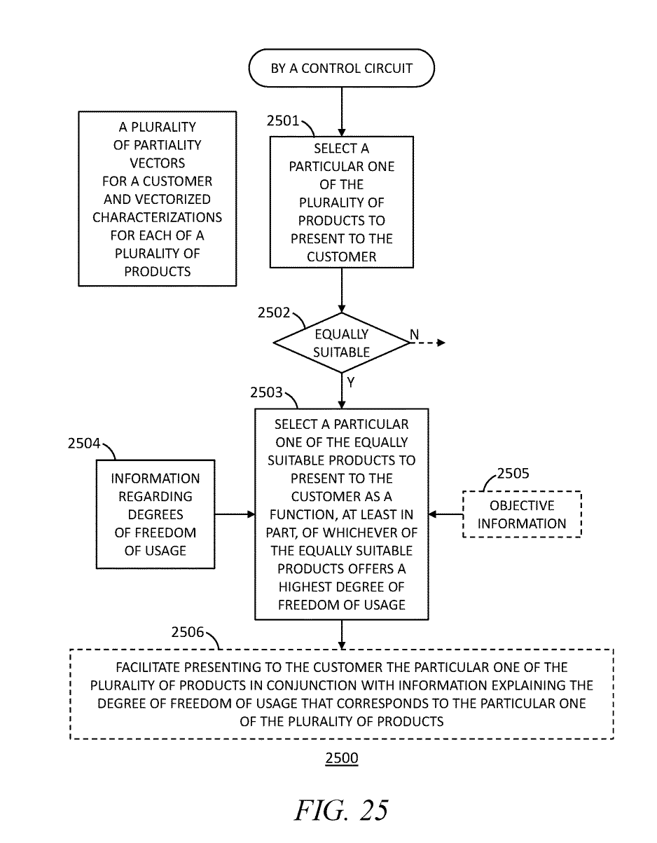

It is possible that more than one product will appear equally suitable to present to a customer when assessing various products as a function of the customer's partiality vectors 1307 and vectorized product characterizations 1304 per these teachings. FIG. 25 presents a process 2500 to address such an outcome.

Per this process 2500 the control circuit 1301 selects (at block 2501), or perhaps more accurately, attempts to select a particular one of a plurality of products to present to a customer as a function of a plurality of partiality vectors 1307 for the customer and vectorized product characterizations 1304 for each of a plurality of products. Such an activity can be in support of, for example, selecting a particular product to offer to a customer for purchase or for selecting a particular sample of a product to deliver to the customer without cost to the customer (and possibly to ship to the customer without the customer having ordered this particular product). Another example in these regards would be to select a product (or a sample of a product) to deliver to the customer without the customer having first ordered the product along with an offer or other opportunity to make future shipments of this product to the customer on some regular automated basis subject to a corresponding charge.

At decision block 2502 the control circuit 1301 determines when the foregoing activity yields a plurality of products that are equally suitable in view of the aforementioned partiality vectors 1307 (as well as any applicable vectorized product characterizations 1304). By one approach this inquiry will identify multiple products that are exactly equally suitable by whatever metric or metrics are appropriately in use for the particular partialities and/or product characterizations in play. By another approach this inquiry can serve to identify multiple products that may not be exactly equally suitable but which are within some predetermined distance from one another as again measured by whatever metric or metrics are appropriately in use.

In the absence of detecting that there are a plurality of products that are equally suitable, this process 2500 can accommodate any of a variety of responses. Examples of responses can include transitioning to other activities and/or states pending a need to select another product to present to the customer per this process.

When there are a plurality of equally suitable products, at block 2503 the control circuit 1301 selects a particular one of the equally suitable products to present to the customer as a function, at least in part, of whichever of the equally suitable products offers a highest degree of freedom of usage. The control circuit 1301 can draw upon information 2504 regarding degrees of freedom of usage as stored, for example, at a corresponding memory 1302. Such information may be available for only some of the plurality of products, or at least a majority of the plurality of products, or all of the plurality of products as desired. By another approach, in lieu of the foregoing or in combination therewith, the control circuit 1301 can be further configured to itself determine, on an as-needed basis, the degree of freedom of usage for particular ones of the products that were found to be equally suitable.

Generally speaking, consideration of these degrees of freedom of usage can include consideration of a future value proposition and/or a past value proposition as desired. By one approach each degree of freedom of usage can correspond to a different modality of usage. As a simple illustrative example in these regards, a product such as vinegar has a first modality of use as an edible commodity, a second modality of use as a cleaning agent for laundry, and a third modality of use as a household cleaning agent. Conversely, vegetables oil has a modality of use as an edible commodity but cannot also be used as a cleaning agent for laundry or as a household cleaning agent. In a situation where both vinegar and vegetable oil appear to be equally suitable for presentation to a customer, the control circuit 1301 can select the vinegar to present to the customer because the vinegar offers a higher degree of freedom of usage as compared to the vegetable oil.

In such a case it will typically be useful to filter or otherwise assess such degrees of freedom with respect to the customer's own partiality vectors; in particular, to filter/assess a product with greater emphasis/weight being given to particular degrees of freedom that more strongly align with one or more of the customer's partiality vectors as compared to degrees of freedom that do not align as strongly with the customer's partiality vectors (or which, in fact, are misaligned with the customer's partiality vectors). As a simple illustrative example in these regards, a given liquid soap may have three degrees of freedom in that the soap may be useful for washing dishes, shampooing, and personal shaving, and the shaving modality may in particular align with the customer's partialities, but the entirety of the customer's partialities may align best with shaving soaps that also moisturize. In that case this particular product may be less preferable as compared to other options that better align overall with the customer's partialities.

As represented at optional block 2505, the foregoing consideration can also optionally take into account one or more items of objective information. This can include objective information regarding the customer and/or objective logistical information regarding providing particular products to the customer. Examples of objective information include but are not limited to location information (regarding the customer and/or the product itself), budget information for the customer, age information for the customer, gender information for the customer, product availability (such as immediate or near-term availability to be shipped to the customer), shipping limitations that apply to the product and/or the location of the customer, and any of a variety of applicable legal limitations that apply with respect to the customer, the customer's location, the product itself, and/or with respect to transport and/or delivery of the product, to note but a few examples in these regards.

Having selected a particular one of the equally suitable products to present to the customer, at optional block 2506 the control circuit 1301 can then facilitate presenting to the customer the selected particular one of the plurality of products in conjunction with information that explains the degree of freedom of usage that corresponds to the selected product. By this approach the customer can be specifically informed about, for example, various modalities of usage that apply with respect to the identified product to thereby better ensure that the customer is fully informed and cognizant of such benefits.

Pursuant to these teachings, a control circuit has access to information including a plurality of partiality vectors for a customer and vectorized product characterizations for each of a plurality of products. The control circuit is also configured to develop a baseline representation of an experiential routine for the customer and to then use the aforementioned information to develop responses to detected deviations from that baseline representation.

These teachings will accommodate developing that baseline representation using any of a variety of information sources. Examples include but are not limited to information directly input by the customer (including customer-provided feedback offered in response to being provided with a product), social networking postings, customer-related location information, customer-related scheduling information, presence information regarding the customer (including information regarding a physical presence of the customer as well as a virtual presence of the customer), web-surfing activities corresponding to the customer, and purchasing information corresponding to the customer. These teachings will also accommodate using information from any of a variety of sensors including sensors that are integral to a portable device that is personal to the customer as well as sensors that are remotely located with respect to the customer.

The control circuit can be further configured to identify at least one product to assist the customer with restoring the customer's order consistent with their partiality vectors and/or to identify at least one product to assist the customer with realizing an aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

An person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

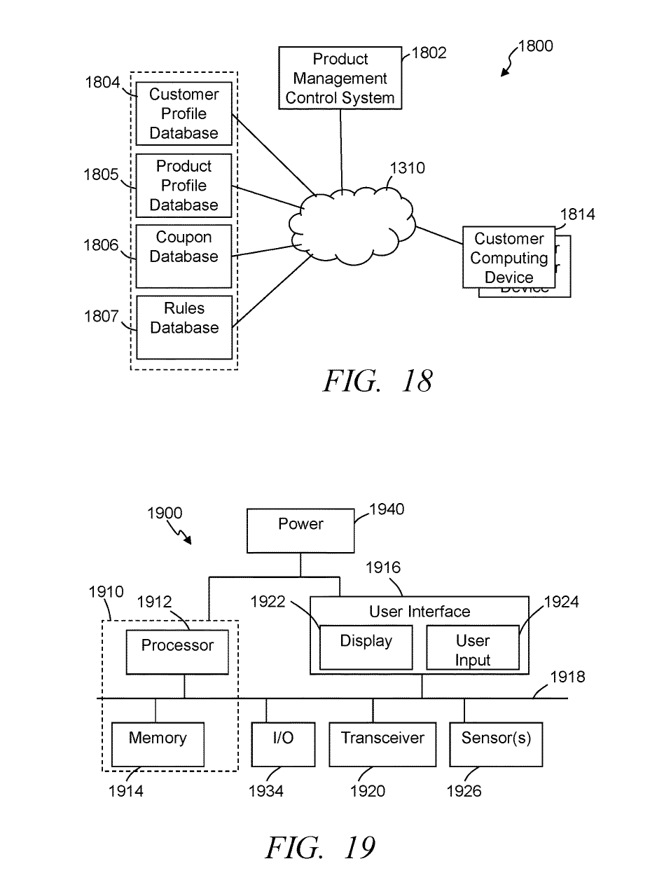

FIG. 18 illustrates a simplified block diagram of a retail product coupon offer distribution system 1800 that distributes customized coupon offers, in accordance with some embodiments. The retail product coupon distribution system includes one or more product management control system 1802 communicatively coupled with multiple databases 1804-1807 over a distributed computer and/or communication network 1310. The databases can include a customer profile database 1804, a product profile database 1805, a coupon database 1806, a rules database 1807, other such databases, and typically a combination of two or more of such databases. These databases may be maintained in a single memory system, each implemented in a separate memory system, distributed over multiple memory systems, and/or some or all of the databases may be mirrored over multiple different and geographically distributed memory systems. In some embodiments, the coupon product management control system 1802 may be communicatively coupled with one or more customer computing devices 1814 (e.g., smartphones, tablets, laptops, computers, smartwatches, and/or other such computing devices).

The customer database 1804 includes a customer profile database that stores multiple customer profiles that are each associated with one of multiple different customers and/or potential customers. Each customer profile includes an identifier of the respective customer and at least a set of customer partiality vectors 1307. As described above, each customer partiality vector has a magnitude that corresponds to a determined magnitude of a strength of the belief, by the customer, in an amount of good that comes from an amount of order imposed upon material space-time by a corresponding particular partiality. The product database 1805 includes a product profile database that stores multiple product profiles each corresponding to one of multiple different products and includes a set of product partiality vectors 1304 having at least a magnitude that represents a reduction of exerted effort associated with the corresponding product to pursue a corresponding partiality.

The product management control system 1802 can access the customer database and the product database to identify a set of customers of the multiple customers that each has associated a customer partiality vector that has a threshold relationship with at least one product partiality vector of the set of product partiality vectors that are associated with a product of interest. The product of interest may be selected based on input from a supplier of the product of interest, based on a desire by a shopping facility to increase sales of that product, based on an increased interest of a product, and/or other such reasons. In some embodiments, the product management control system accesses and applies one or more alignment rules from the rules database to customer partiality vectors and product partiality vectors in determining a level of agreement and/or a level of disagreement between customer partiality vectors and product partiality vectors. For example, a first alignment rule may direct the product management control system to evaluate the set of product partiality vectors of the product of interest and/or customer partiality vectors associated with the customer to identify each partiality vector that has a magnitude greater than a first magnitude threshold. This may correspond to identifying partiality vectors that correspond to potentially significant factors that may be considered by customers. Some embodiments may apply an alignment rule that dictates a threshold number of product partiality vectors and corresponding customer partiality vectors having a threshold magnitude. Still other embodiments may apply alignment rules that identify customer partiality vectors having a threshold magnitude, and filtering products from a set of products to identify products that have one or more corresponding product partiality vectors that have a magnitude of at least a corresponding product partiality threshold.

Some embodiments further apply one or more alignment rules in determining alignment between customer partiality vectors and product partiality vectors based at least in part through vector dot product rules. Through the application of the rules some embodiments determine a value indicating a relative alignment between partiality vectors. In some instances, the value may further provide a positive, zero, or negative value, with positive values indicating a degree of directional alignment, while negative values indicate a degree of misalignment. Further, the alignment rules may enable a multi-dimensional surface representation of an alignment solution. For example, in some applications a normalization of the value relative to a maximum possible value of a dot product can correspond to a maximum value of a sine wave representation of the surface as a best solution. Additionally or alternatively, some embodiments applying one or more alignment rules provide a degree of alignment between the consumer partiality vectors and product partiality vectors through a dot product of the these vectors with a higher value indicating a greater alignment.

Again, the product management control system 1802 accesses the customer database and the product database to identify a set of one or more customers of the multiple customers that each have associated a customer partiality vector that has a threshold relationship with at least one product partiality vector of the set of product partiality vectors that are associated with a product of interest. Based on this identified set of customers, the product management control system can, in some implementations, identify for a particular customer of the set of customers one or more partiality vectors that have a coupon threshold alignment between one or more customer partiality vectors and one or more corresponding product partiality vectors. When the threshold relationship is identified, some embodiments distribute customized coupon offers and/or other marketing information relative to the first product that is distinct for each customer of the set of customers based on the alignment between the corresponding product partiality vector and customer partiality vector of the first product. These customized coupon offers and/or marketing information can be presented to the customer through one or more methods (e.g., e-mail, text message, printing on a receipt, instant message, a marketing banner on an Internet site, mailing of a physical coupon, etc.). The coupon database 1806 stores coupon offer information and further links the offer information with one or more corresponding customer partiality vectors, product partiality vectors, products, customers and/or other associations. In some instances, for example, the coupon database links customers with coupon offers and/or offer information in response to the offer and/or information being associated with and/or communicated to the customer. Similarly, the linking improves the access to the coupon offer information based on the one or more partiality vectors identified that have the threshold alignment. Again, in some embodiments the offer information highlights the characteristics of the product that correspond to the one or more partiality vectors identified that have the threshold alignment.

Some embodiments cause a coupon offer and/or marketing material to be communicated over a distributed communications network 1310 and received through customers' computing devices 1814 by the respective customer. The coupon offers identify the product and further highlight characteristics corresponding to the aligned customer and product partiality vectors. In some instances, the coupon offers may further include one or more incentives to purchase the presented product. The incentive may include a discount in the purchase price (e.g., a percentage discount (e.g., 10%, 20%, some other percentage), a fixed amount of reduction (e.g., $1, $0.50, etc.), an increased quantities (e.g., buy one and get one free, buy two and get one free, purchase an increased size for the price of a smaller size, etc.), a mail in rebate, other such incentives, or combination of two or more incentives.

The coupon threshold alignment may be specific to a partiality vector such that at least some partiality vectors have different coupon alignment thresholds. Further, the coupon alignment threshold for a particular partiality vector may further vary based on the customer and/or a number and/or degree of alignment between two or more other corresponding product and customer partiality vectors. Still further, in some embodiments the coupon alignment threshold of a partiality vector or the combination of multiple coupon alignment thresholds are typically set based on a statistical probability that a customer is expected to change future purchasing habits in responds to appropriate marketing information being provided to the customer. The statistical probability can be determined based on historic marketing and/or coupon efforts having varying degrees of alignment between one or more corresponding customer and product partiality vectors, and in some instances specific partiality vectors. For example, it may be determined, based on numerous coupon and/or marketing efforts for a first product to a set of different customers, that 60% of those customers changed their purchasing pattern relative to the first product when the customer has at least a threshold alignment value between a particular customer and product partiality vector. As another example, it may be determined that 80% of a second set of customers has changed their subsequent purchasing patterns relative to the first product when there is a first threshold alignment between corresponding first customer and product partiality vector and a second threshold alignment between corresponding second customer and product partiality vectors.

Accordingly, in some embodiments, a coupon threshold may be set at an alignment value where it is anticipated that a customer is more likely to make a change to her/his future purchasing pattern. In other instances, a coupon threshold may be set at an alignment value where there is a historic threshold statistical probability (e.g., 30%, 40%, 48%, 85%, or some other historical probability) that the customer will change purchasing patterns and purchase the marketed product in the future. The coupon threshold may further vary depending on a product supplier's willingness to absorb the cost of the coupon and marketing to customers that do not make changes in purchase patterns. Similarly, a retail entity may set alignment threshold and/or coupon thresholds at levels in order to develop a customer's level of trust over time that when they receive coupons and/or marketing materials they are going to trust those coupons and/or marketing materials based on the customer being happy with previous changes in purchasing patterns made based on receiving previous coupon and/or marketing information for other products. For example, a coupon threshold of alignment between partiality vectors may be set to limit coupons and/or marketing to customers unless there is predicted at least an 85% probability that the customer is going to modify her/his purchasing pattern so that the customer will over time learn to trust the coupons and/or marketing materials as being directed to products that customer actually will want to purchase.

Further, the coupons and corresponding marketing information and/or material that is to be directed to different customers for a first product can be different for two or more of the customers, and often is different for each of the different customers. As described above, each product has different magnitudes and directional relationships for each of multiple different product partiality vectors, and customers (including potential customers) similarly have different magnitudes and directional relationships for each of multiple different customer partiality vectors. Accordingly, different customers may be interested in the same product based on different partiality vectors. Thus, the coupons and associated marketing materials and/or information directed to the different customers can vary corresponding to the alignment of different partiality vectors. For example, a first customer may have threshold alignment values corresponding to a first product for a “price per quantity” partiality vector and a “prevention of cruelty to animals” partiality vector; while a second customer may have threshold alignment values corresponding to the first product for an “organic” partiality vector and “efficiency of use” partiality vector. Accordingly, the coupon and/or marketing information presented to the first customer can emphasize “price per quantity” and “prevention of cruelty to animals; while the coupon and/or marketing information presented to the second customer emphasizes “organic” and “efficiency of use.”

By evaluating the alignment between customer and product partiality vectors, the retail product coupon offer distribution system 1800 is not relying on historic purchases or preferences. Historically, other vendors have distributed coupons in mass in the hopes that they are used by customers and those customers end up liking the product. Some vendors distribute coupons based on historic purchases. However, such mass coupon distributions have very limited success in actually being used, and are less effective in changing a customer's purchasing behavior. Further, such systems often cannot associate subsequent purchases to the change in behavior. The retail product coupon distribution system, however, provides precision, targeted coupon offerings and/or marketing information to customers in a way that is predicted to result in changes in customers' purchase behaviors. The retail product coupon offer distribution system 1800 utilizes the customer's foundations, beliefs and reasoning in the form of the partiality vectors that dictated historic purchases and preferences. Accordingly, the system takes advantage of this underlying basis for decision making and identifies products that the customer is predicted to want to purchase, and not just products for which a supplier or manufacturer is attempting to increase sales. Accordingly, the coupon offers are provided that are likely to be viewed by the customer as beneficial, and the customer more fully appreciates the coupon offer and the corresponding information that support the customer's values. Further, because of the alignment of the product partiality vectors with the customer partiality vectors, some customers over time will rely on the coupon offers in making subsequent purchasing decisions and/or making changes in purchasing behaviors. Still further, some customers over time will rely on the offers that the offers will not have to include an incentive for making a purchase of the product.

Typically, the customization of the coupon offer (including the corresponding marketing material) emphasizes the relationship between the one or more aligned customer and product partiality vectors. In some embodiments, the product management control circuit, in customizing the coupon offers for each customer, uses the threshold alignment between partiality vectors and emphasizes to the corresponding customer the correlation between the customer partiality vector associated with the customer and the corresponding product partiality vector. For example, the emphasis highlights the features and/or characteristics of the product that contribute to at least the magnitude of the aligned product partiality vector. Some embodiments may select a sub-set of one or more characteristics and/or factors of multiple characteristics and/or factors that contribute to at least the magnitude of the product partiality vector. The selection of which characteristics and/or factors may be based on how much each characteristic and/or feature contribute to the magnitude, with characteristics and/or factors having a greater effect on the magnitude having a high priority to be selected. Some embodiments additionally or alternatively select characteristics and/or factors that contribute to multiple different product partiality vectors that have threshold alignments with other customer partiality vectors, allowing emphasis of multiple different partiality vectors in attempts to enhance the effectiveness of the coupon and the likelihood the customer will change her/his purchasing pattern.

In some embodiments, the product management control system 1802 can consider temporal factors regarding presenting the coupon offer. Some embodiments evaluate timing of when to present a coupon offer to an identified customer in attempts to enhance the likelihood that the customer will consider the offer, and in some instances is predicted to view the coupon offer more favorably that at one or more other times. In some implementations the product management control system further evaluates statistics representative of, for example, that like customers tend to be more receptive in the morning versus the evening, a set of customers tend to be more receptive to offers on Friday versus the rest of the week, that a set of customers are more receptive before meal times, and other such statistical considerations. These statistical factors can be acquired over time based on feedback detected related to previous coupon offers, customer input (e.g., from questionnaires, interviewing, surveys, etc.). In some embodiments, the product management control system may consider geographical factors associated with where the customer is when receiving a given coupon offer, which may be presented electronically (e.g., on a customer's computing device 1814), in person (e.g., at a retail store location), etc. Again, statistical evaluations of responses (e.g., subsequent purchasing, changes in purchase habits, etc.) can be performed relative to different locations regarding where geographically a customer is when receiving and/or viewing a coupon offer. Still further, some embodiments consider modes of presenting the coupon offer factors. Some customer's may be more receptive to offers when received via email, versus received via text message, versus received in person, versus received as a phone call, offered at a point-of-sale system, offered on a purchase receipt, and/or other such methods of presenting the coupon offer. In many implementations, multiple different types of factors are considered. Further, different factors can be maintained for each customer or sets of customers, and the offering may be presented according to one or more of these factors, which can focus coupon offers to customers and/or potential customers that are predicted to more likely result in the customer acting on the coupon offers and predicted to ultimately change buying behavior as a result.

The product management control circuit, in identifying the set of customers, may in some instances further attempt to limit the identified set of customers to those customers that are expected, based on the threshold relationship between the customer partiality vector and the product partiality vector, to change future behavior and make a subsequent purchase of a particular product even without the coupon offer. Based on historic evaluations of alignment values between customer and product partiality vectors, one or more threshold alignment values may be identified that indicate that a customer has a relatively high probability of changing her/his purchasing behavior when marketing information focused on the characteristics and/or factors of the product that define the magnitude of the one or more partiality vectors that have the threshold alignment with the customer partiality vectors. For example, it may be determined based on statistical analysis of historic purchase patterns that a customer has a 90% probability of changing her/his future purchasing behavior, then a coupon that provides a reduced purchase price for the product is not needed to induce the future purchasing behavior change and instead marketing materials without the coupon is expected to change the future behavior.

Again, in some embodiments the product management control circuit, in identifying the set of customers that are expected to change future purchasing behavior attempts to identify the set of customers that each have associated with that customer multiple different customer partiality vectors that each have a respective threshold relationship with at least one of the multiple different product partiality vectors of the set of partiality vectors associated with a product. Typically, the probability of changing a customer's future purchasing behavior increases as the number of aligned partiality vectors increase. Further, the probability of modifying a customer's purchase behavior increases as the degree of alignment and/or magnitude of alignment between the numbers of aligned partiality vectors increases. Accordingly, the system attempts to identify products that have product partiality vectors that align with multiple customer partiality vectors for a given customer at relatively high alignment values. Again, some embodiments consider alignment values that are greater than respective threshold values. The threshold values may vary, however, depending on the number of other partiality vectors that align and the corresponding alignment values.

Similarly, the product management control system 1802 may further evaluate customers and products to identify customer that are predicted to not change purchasing behaviors. In some embodiments, the product management control system identifies a set of customers that have at least one customer partiality vector that has the threshold relationship with at least one of the set of partiality vectors associated with a first product, that are predicted to use a coupon offer to purchase the first product, and that are not expected to change future behavior and make a subsequent purchase of the first product without the coupon offer. Based on this identification, the product management control system can, in at least some implementations, prevents customizing coupon offers of the first product for the second set of customers. Some embodiments utilize purchase history information to, at least in part, to identify one or more of the second set of customer not predicted to change their purchase behavior. For example, based on purchase history and threshold alignment values between sets of customer and product partiality vectors, some customers can be identified that are predicted to buy a product with a coupon but not buy the product without a coupon (e.g., based on history of exchanging money for reduced effort). Over time the system can track a customer's cost to benefit exchange rate that converges to a consistent exchange rate at least with respect to one or more partiality vectors. When a product without a coupon exceeds the exchange rate where this customer typically does not participate in those transactions then it is identified that the coupon is providing a temporary exchange rate alignment but without the coupon the person does not value the reduction in effort to justify the cost.

Further, the product management control system in identifying the second set of customers who are predicted not to change their purchase behavior can identify the second set of customers based on each of the second set of customers being associated with at least one customer partiality vector with a corresponding negative threshold magnitude that contradicts at least on product partiality vector associated with a product. This negative or contradictory alignment between customer and product partiality vectors can be identified as a deterrent for the customer, and as such the customer is predicted not to purchase the product or at least not change her/his purchase behavior to repeatedly purchase the product. For example, when a customer has a first magnitude for a prevention of animal cruelty partiality vector, and a product indicates that the product was tested on animals, the evaluation the prevention of animal cruelty partiality vectors of the customer and product may indicate a negative or contradictory alignment value indicating a prediction that the customer will not purchase this product. Accordingly, the customer can be excluded from receiving the customized coupon based on this negative alignment.

As described above, the product management control system, a marketing system communicatively coupled with the product management system and/or a third party marketing system may use the alignment values between product partiality vectors and customer partiality vectors to customized the coupon offers to emphasize one or more aspects of the product that correspond to the alignment between partiality vectors. Accordingly, the product management control system 1802 in customizing the coupon offers can emphasize, for each of multiple different customers of the set of customers, at least a different one of multiple different characteristics of a product that has the threshold relationship with the customer partiality vector. For example, the system may identify a first threshold alignment between a first customer's and a first product's “prevention of animal cruelty” partiality vectors and cause the coupon offer and/or marketing information to emphasize the prevention of animal cruelty aspects associated with the first product; the system may identify a second threshold alignment between a second customer's and the same first product's “cleaning efficiency” partiality vectors and cause the coupon offer and/or marketing information directed to the second customer to emphasize the cleaning efficiency provided by the first product; and the system may identify a third threshold alignment between a third customer's and the same first product's “safe around children” partiality vectors and cause the coupon offer and/or marketing information directed to the third customer to emphasize the safety for use of the first product around children. The customization may further be limited to information corresponding to customer and product partiality vectors having at least a customization threshold of alignment. This threshold may be greater than other thresholds so that the customization emphasizes those partiality vectors expected to have the most significant influence on the customer's behavior. In other instances, the system can identify a set of one or more partiality vectors that are found to have the greatest level of alignment. In yet other instances, the system can identify a set of one or more partiality vectors that have historically been determined to be a significant factor and/or a leading factor considered by the customer in making purchases. This may be determined based on previous coupon offers communicated and/or other marketing presented to the customer and subsequent customer purchases, customer's direct feedback (e.g., responding to a survey, tracking social media, etc.), and other such historic data.

As described above, some embodiments further process the partiality vectors in attempts to identify customers predicted to change behavior without a coupon offer, and instead change behavior in response to marketing information without the coupon. In some implementations, the product management control system further evaluates customers' and products' partiality vectors to identify a sets of customers that each have at least one customer partiality vector, and typically multiple partiality vectors having respective enhanced threshold relationships with a second set of one or more and typically multiple product partiality vectors of a first product. Based on the enhanced threshold relationship the system predicts that the set of customers are expected to change future behavior and make a subsequent purchase of the first product without the coupon offer. Product information of the first product and one or more of the set of partiality vectors is communicated to the respective second set of customers without a customized coupon offer. The product information emphasizes the correlation between the second set of customer partiality vectors and the corresponding product partiality vector to be communicated.

Further, the circuits, circuitry, systems, devices, processes, methods, techniques, functionality, services, servers, sources and the like described herein may be utilized, implemented and/or run on many different types of devices and/or systems. FIG. 19 illustrates an exemplary system 1900 that may be used for implementing any of the components, circuits, circuitry, systems, functionality, apparatuses, processes, or devices of the control circuit 601, the product management control system 1802, a customer computing device 1814, databases, and/or other above or below mentioned systems or devices, or parts of such circuits, circuitry, functionality, systems, apparatuses, processes, or devices. For example, the system 1900 may be used to implement some or all of the product management control system 1802, the databases 1804-1807, and/or other such components, circuitry, functionality and/or devices. However, the use of the system 1900 or any portion thereof is certainly not required.

By way of example, the system 1900 may comprise a control circuit or processor module 1912, memory 1914, and one or more communication links, paths, buses or the like 1918. Some embodiments may include one or more user interfaces 1916, and/or one or more internal and/or external power sources or supplies 1940. The control circuit 1912 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1912 can be part of control circuitry and/or a control system 1910, which may be implemented through one or more processors with access to one or more memory 1914 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 1900 may be used to implement one or more of the above or below, or parts of, components, circuits, systems, processes and the like. For example, the system may implement the product management control system 1802 with the control circuit being a product management control circuit.

The user interface 1916 can allow a user to interact with the system 1900 and receive information through the system. In some instances, the user interface 1916 includes a display 1922 and/or one or more user inputs 1924, such as buttons, touch screen, track ball, keyboard, mouse, etc., which can be part of or wired or wirelessly coupled with the system 1900. Typically, the system 1900 further includes one or more communication interfaces, ports, transceivers 1920 and the like allowing the system 1900 to communicate over a communication bus, a distributed computer and/or communication network 1310 (e.g., a local area network (LAN), the Internet, wide area network (WAN), etc.), communication link 1918, other networks or communication channels with other devices and/or other such communications or combination of two or more of such communication methods. Further the transceiver 1920 can be configured for wired, wireless, optical, fiber optical cable, satellite, or other such communication configurations or combinations of two or more of such communications. Some embodiments include one or more input/output (I/O) ports 1934 that allow one or more devices to couple with the system 1900. The I/O ports can be substantially any relevant port or combinations of ports, such as but not limited to USB, Ethernet, or other such ports. The I/O interface 1934 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

The system 1900 comprises an example of a control and/or processor-based system with the control circuit 1912. Again, the control circuit 1912 can be implemented through one or more processors, controllers, central processing units, logic, software and the like. Further, in some implementations the control circuit 1912 may provide multiprocessor functionality.

The memory 1914, which can be accessed by the control circuit 1912, typically includes one or more processor readable and/or computer readable media accessed by at least the control circuit 1912, and can include volatile and/or nonvolatile media, such as RAM, ROM, EEPROM, flash memory and/or other memory technology. Further, the memory 1914 is shown as internal to the control system 1910; however, the memory 1914 can be internal, external or a combination of internal and external memory. Similarly, some or all of the memory 1914 can be internal, external or a combination of internal and external memory of the control circuit 1912. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 1310. The memory 1914 can store code, software, executables, scripts, data, content, lists, programming, programs, log or history data, user information, customer information, product information, and the like. While FIG. 19 illustrates the various components being coupled together via a bus, it is understood that the various components may actually be coupled to the control circuit and/or one or more other components directly.

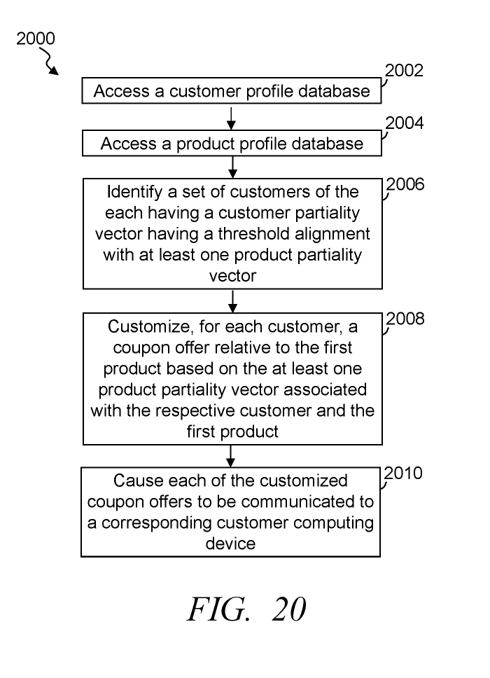

FIG. 20 illustrates a simplified flow diagram of an exemplary process 2000 of distributing retail product coupon offerings, in accordance with some embodiments. In step 2002, a customer profile database 1804 is accessed. The customer profile database maintains customer profiles of multiple customers and/or potential customers. Each customer profile is associated with one of the customer and comprises a set of customer partiality vectors having a magnitude that corresponds to a determined magnitude of a strength of the belief, by the customer, in an amount of good that comes from an amount of order imposed upon material space-time by a corresponding particular partiality.

In step 2004, a product profile database 1805 is accessed that stores and maintains product profiles that each corresponds to one of multiple products, and typically tens or hundreds of thousands of different products. Each product profile includes a set of product partiality vectors that each has a magnitude that represents a reduction of exerted effort associated with the corresponding product to pursue a corresponding partiality. In step 2006, alignment rules from the alignment database are applied to identify a set of customers of the multiple customers that each has associated a customer partiality vector that has a threshold relationship with at least one product partiality vector of the set of partiality vectors associated with a first product. In step 2008, based on the alignment rules a coupon offer is customized, for each customer of the set of customers. The coupon offers are relative to the first product, and are distinct for each customer of the set of customers based on the at least one product partiality vector associated with the respective customer and the first product. In step 2010, the product management control system 1802 causes each of the customized coupon offers for each of the set of customers to be communicated over a distributed communications network to be received through a respective customer computing device.

Some embodiments, in customizing the coupon offers for each customer emphasize to the corresponding customer the correlation between the one or more customer partiality vectors associated with the customer and the one or more product partiality vectors. Further, the identification of the set of customers can include identifying the set of customers that are expected, based on the threshold relationship between the customer partiality vector and the product partiality vector, to change future behavior and make a subsequent purchase of the first product without the coupon offer. As described above, the customers that are expected to change future purchasing behavior are identified in part based on the degree of alignment between one or more customer partiality vectors and product partiality vectors. Some embodiments identify the set of customers that each has associated with that customer multiple customer partiality vectors that each has a respective threshold relationship with at least one of the multiple product partiality vectors of the set of partiality vectors associated with the first product. In some instances, the greater number of aligned partiality vectors at respective threshold values the greater the predicted change of behavior.

Some embodiments identify a second set of customers that have at least one customer partiality vector that has the threshold relationship with at least one of the set of partiality vectors associated with the first product, that are predicted to use a coupon offer to purchase the first product, and that are not expected to change future behavior and make a subsequent purchase of the first product without the coupon offer. Based on the identification of the second set, the system prevents customizing coupon offers of the first product for the second set of customers. Additionally or alternatively, some embodiments identifying a second set of customers based on each of the second set of customers being associated with at least one customer partiality vector with a corresponding threshold magnitude that contradicts at least on product partiality vector associated with the first product.

The customization of the coupon offers often includes emphasizing, for each of multiple different customers of the set of customers, at least a different one of multiple different characteristics of the first product that has the threshold relationship with the customer partiality vector. Some embodiments identify a second set of customers that each has at least one customer partiality vector having an enhanced threshold relationship with a second set of at least of the one product partiality vectors, and who are expected to change future behavior and make a subsequent purchase of the first product without the coupon offer. Based on the identified second set of customers, the system can cause product information regarding the first product and emphasizing the correlation between the second set of partiality vectors and the corresponding product partiality vector to be communicated to the respective second set of customers without a customized coupon offer.

Some embodiments, provide a retail product coupon offer distribution system, comprising: a customer profile database comprising customer profiles of multiple customers, wherein each customer profile is associated with one of the multiple customers and comprises a set of customer partiality vectors having a magnitude that corresponds to a determined magnitude of a strength of the belief, by the respective customer, in an amount of good that comes from an amount of order imposed upon material space-time by a corresponding particular partiality; a product profile database comprising product profiles each corresponding to one of multiple products and comprising a set of product partiality vectors having a magnitude that represents a reduction of exerted effort associated with the corresponding product to pursue a corresponding partiality; and a product management control circuit communicatively coupled with the customer profile database and the product profile database, and configured to: identify a set of customers of the multiple customers that each have associated a customer partiality vector that has a threshold alignment with at least one product partiality vector of the set of product partiality vectors associated with a first product; and for each customer of the set of customers, customize a coupon offer relative to the first product that is distinct for each customer of the set of customers based on the at least one product partiality vector associated with the respective customer and the first product, wherein the product management control circuit is configured to communicate over a distributed communications network the customized coupon offer to be received through a respective customer computing device.

Some embodiments provide methods of distributing retail product coupons, comprising: accessing a customer profile database comprising customer profiles of multiple customers, wherein each customer profile is associated with one of the customer comprises a set of customer partiality vectors having a magnitude that corresponds to a determined magnitude of a strength of the belief, by the customer, in an amount of good that comes from an amount of order imposed upon material space-time by a corresponding particular partiality; accessing a product profile database comprising product profiles each corresponding to one of multiple products and comprising a set of product partiality vectors having a magnitude that represents a reduction of exerted effort associated with the corresponding product to pursue a corresponding partiality; and identifying a set of customers of the multiple customers that each have associated a customer partiality vector that has a threshold alignment with at least one product partiality vector of the set of partiality vectors associated with a first product; customizing, for each customer of the set of customers, a coupon offer relative to the first product that is distinct for each customer of the set of customers based on the at least one product partiality vector associated with the respective customer and the first product; and causing each of the customized coupon offers to be communicated over a distributed communications network to be received through a customer computing device.

Some embodiments provide an apparatus comprising: memory having stored therein: information including a plurality of partiality vectors for a customer; and vectorized characterizations for each of a plurality of products, wherein each of the vectorized characterizations indicates a measure regarding an extent to which a corresponding one of the products accords with a corresponding one of the plurality of partiality vectors; and a control circuit operably coupled to the memory and configured to: develop a baseline representation of an experiential routine for the customer; and use the plurality of partiality vectors and vectorized characterizations to develop responses to detected deviations from the baseline representation.

In some variations, the control circuit is configured to develop the baseline representation using, at least in part, direct input from the customer. In some variations, the direct input comprises feedback from the customer in response to at least one of the responses. In some variations, the control circuit is configured to develop the baseline representation using, at least in part, social networking postings corresponding to the customer. In some variations, the control circuit is configured to develop the baseline representation using, at least in part, location information corresponding to the customer. In some variations, the control circuit is configured to develop the baseline representation using, at least in part, scheduling information corresponding to the customer. In some variations, the control circuit is configured to develop the baseline representation using, at least in part, purchasing information corresponding to the customer. In some variations, the control circuit is configured to develop the baseline representation using, at least in part, sensor information. In some variations, the sensor information is sourced by a portable device that is personal to the customer. In some variations, the portable device comprises at least one of: a smartphone; a pad/tablet-styled computer; a wrist-worn device; a pendant-styled device; a head-worn device; and a device that comprises part of an article of clothing. In some variations, the sensor information is sourced by third-party devices that are remotely located with respect to the customer. In some variations, the sensor information is sourced by a vehicle that corresponds to the customer. In some variations, the sensor information reflects web surfing activities corresponding to the customer. In some variations, the control circuit is configured to develop the baseline representation using, at least in part, presence information corresponding to the customer. In some variations, the presence information comprises information regarding a physical presence of the customer. In some variations, the presence information comprises information regarding a virtual presence of the customer. In some variations, the developed response to a detected deviation from the baseline representation may selectively comprise at least one of: identifying at least one product to assist the customer with restoring the customer's order consistent with their partiality vectors; and identifying at least one product to assist the customer with realizing an aspiration. In some variations, the developed response to a detected deviation from the baseline representation may further selectively comprise: updating the baseline representation of the experiential routine for the customer. In some variations, the control circuit is configured to develop the baseline representation of an experiential routine for the customer by, at least in part: accessing objective demographic information regarding the customer; using the objective demographic information to select a particular template from a plurality of candidate templates that each comprise a generic baseline representation of an experiential routine for customers who share similar objective demographic information; using later-received supplemental information regarding the customer to personalize the selected generic baseline representation of an experiential routine for the customer to then use as the baseline representation. And in some variations, the objective demographic information comprises at least one of: customer name information; family information; address information; budget information; age information; gender information; and race information.

This application is related to, and incorporates herein by reference in its entirety, each of the following U.S. provisional applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,804 filed Mar. 15, 2017; 62/471,830 filed Mar. 15, 2017; 62/479,525 filed Mar. 31, 2017; 62/480,733 filed Apr. 3, 2017; 62/482,863 filed Apr. 7, 2017; 62/482,855 filed Apr. 7, 2017; and 62/485,045, filed Apr. 13, 2017.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A retail product coupon offer distribution system, comprising:
a customer profile database comprising customer profiles of multiple customers, wherein each customer profile is associated with one of the multiple customers and comprises a set of customer partiality vectors having a magnitude that corresponds to a determined magnitude of a strength of the belief, by the respective customer, in an amount of good that comes from an amount of order imposed upon material space-time by a corresponding particular partiality;
a product profile database comprising product profiles each corresponding to one of multiple products and comprising a set of product partiality vectors having a magnitude that represents a reduction of exerted effort associated with the corresponding product to pursue a corresponding partiality; and
a product management control circuit communicatively coupled with the customer profile database, and the product profile database, and configured to apply alignment rules from a rules database to: identify a set of customers of the multiple customers that each have associated a customer partiality vector that has a threshold alignment with at least one product partiality vector of the set of product partiality vectors associated with a first product; and for each customer of the set of customers, customize a coupon offer relative to the first product that is distinct for each customer of the set of customers based on the at least one product partiality vector associated with the respective customer and the first product, wherein the product management control circuit is configured to communicate over a distributed communications network the customized coupon offer to be received through a respective customer computing device.

2. The system of claim 1, wherein the product management control circuit, in customizing the coupon offers for each customer, is configured to emphasize to the corresponding customer the correlation between the customer partiality vector associated with the customer and the product partiality vector.

3. The system of claim 1, wherein the product management control circuit, in identifying the set of customers, is configured to identify the set of customers that are expected, based on the threshold alignment between the customer partiality vector and the product partiality vector, to change future purchasing behavior and make a subsequent purchase of the first product without the coupon offer.

4. The system of claim 3, wherein the product management control circuit, in identifying the set of customers that are expected to change future purchasing behavior is configured to identify the set of customers that each have associated with that customer multiple customer partiality vectors that each have a respective threshold alignment with at least one of the multiple product partiality vectors of the set of partiality vectors associated with the first product.

5. The system of claim 1, wherein the product management control circuit is configured to identify a second set of customers that have at least one customer partiality vector that has the threshold alignment with at least one of the set of partiality vectors associated with the first product, that are predicted to use a coupon offer to purchase the first product, and that are not expected to change future purchasing behavior and make a subsequent purchase of the first product without the coupon offer; and prevent customizing coupon offers of the first product for the second set of customers.

6. The system of claim 5, wherein the product management control circuit in identifying the second set of customers is configured to identify the second set of customers based on each of the second set of customers being associated with at least one customer partiality vector with a corresponding threshold magnitude that contradicts at least on product partiality vector associated with the first product.

7. The system of claim 1, wherein the product management control circuit in customizing the coupon offers is configured to emphasize, for each of multiple different customers of the set of customers, at least a different one of multiple different characteristics of the first product that has the threshold alignment with the customer partiality vector.

8. The system of claim 1, wherein the product management control circuit is configured to identify a second set of customers that each have at least one customer partiality vector having an enhanced threshold alignment with a second set of at least of the one product partiality vectors, and who are expected to change future purchasing behavior and make a subsequent purchase of the first product without the coupon offer; and to cause product information regarding the first product and emphasizing the correlation between the second set of partiality vectors and the corresponding product partiality vector to be communicated to the respective second set of customers without a customized coupon offer.

9. A method of distributing retail product coupons, comprising:
accessing a customer profile database comprising customer profiles of multiple customers, wherein each customer profile is associated with one of the customer comprises a set of customer partiality vectors having a magnitude that corresponds to a determined magnitude of a strength of the belief, by the customer, in an amount of good that comes from an amount of order imposed upon material space-time by a corresponding particular partiality;
accessing a product profile database comprising product profiles each corresponding to one of multiple products and comprising a set of product partiality vectors having a magnitude that represents a reduction of exerted effort associated with the corresponding product to pursue a corresponding partiality;
identifying, based on alignment rules, a set of customers of the multiple customers that each have associated a customer partiality vector that has a threshold alignment with at least one product partiality vector of the set of partiality vectors associated with a first product;
customizing, for each customer of the set of customers and based on the alignment rules, a coupon offer relative to the first product that is distinct for each customer of the set of customers based on the at least one product partiality vector associated with the respective customer and the first product; and
causing each of the customized coupon offers to be communicated over a distributed communications network to be received through a customer computing device.

10. The method of claim 9, wherein the customizing the coupon offers for each customer comprises emphasizing to the corresponding customer the correlation between the customer partiality vector associated with the customer and the product partiality vector.

11. The method of claim 9, wherein the identifying the set of customers comprises identifying the set of customers that are expected, based on the threshold alignment between the customer partiality vector and the product partiality vector, to change future purchasing behavior and make a subsequent purchase of the first product without the coupon offer.

12. The method of claim 11, wherein the identifying the set of customers that are expected to change future purchasing behavior comprises identifying the set of customers that each have associated with that customer multiple customer partiality vectors that each have a respective threshold alignment with at least one of the multiple product partiality vectors of the set of partiality vectors associated with the first product.

13. The method of claim 9, further comprising:
identifying a second set of customers that have at least one customer partiality vector that has the threshold alignment with at least one of the set of partiality vectors associated with the first product, that are predicted to use a coupon offer to purchase the first product, and that are not expected to change future purchasing behavior and make a subsequent purchase of the first product without the coupon offer; and
preventing customizing coupon offers of the first product for the second set of customers.

14. The method of claim 13, wherein the identifying the second set of customers comprises identifying the second set of customers based on each of the second set of customers being associated with at least one customer partiality vector with a corresponding threshold magnitude that contradicts at least on product partiality vector associated with the first product.

15. The method of claim 9, wherein the customizing the coupon offers comprises emphasizing, for each of multiple different customers of the set of customers, at least a different one of multiple different characteristics of the first product that has the threshold alignment with the customer partiality vector.

16. The method of claim 9, further comprising:
identifying a second set of customers that each have at least one customer partiality vector having an enhanced threshold alignment with a second set of at least of the one product partiality vectors, and who are expected to change future purchasing behavior and make a subsequent purchase of the first product without the coupon offer; and
causing product information regarding the first product and emphasizing the correlation between the second set of partiality vectors and the corresponding product partiality vector to be communicated to the respective second set of customers without a customized coupon offer.
